(19) United States
(12) Patent Application Publication
(10) Pub. No.: US 2021/0287234 A1
(43) Pub. Date: Sep. 16, 2021

(54) TRACKING MANUFACTURING INFORMATION

(71) Applicant: QMS TECHNOLOGIES INC., New Westminster (CA)

(72) Inventors: Scott Nicholas Dante LIONELLO, New Westminster (CA); Viatcheslav IVANOV, Langley (CA)

(21) Appl. No.: 17/333,138

(22) Filed: May 28, 2021

Related U.S. Application Data
(63) Continuation of application No. PCT/CA2019/051726, filed on Dec. 2, 2019.
(60) Provisional application No. 62/775,296, filed on Dec. 4, 2018.

(51) Int. Cl. G06Q 30/02; G06F 16/27; H04L 9/32

(52) U.S. Cl. CPC G06Q 30/0201; H04L 9/32; G06F 16/27

(57) ABSTRACT

A computer-implemented method of facilitating tracking of manufacturing information for a plurality of manufacturing customers is disclosed. The method includes causing at least one processor to receive customer defined manufacturing order information associated with a manufacturing order, identify non-confidential customer defined manufacturing order information, produce signals for causing the non-confidential customer defined manufacturing order information to be transmitted to a plurality of peer computers and stored in a distributed ledger such that it is accessible by the plurality of customers, receive vendor defined manufacturing order information associated with the manufacturing order, identify non-confidential vendor defined manufacturing order information, and produce signals for causing the non-confidential order information to be transmitted to the plurality of peer computers and stored in the distributed ledger such that it is associated with the non-confidential customer defined manufacturing order information and is accessible by the plurality of customers. Systems and computer-readable media are also disclosed.

### RELATED APPLICATION

This application is a continuation of International Patent Application No. PCT/CA2019/051726, filed Dec. 2, 2019, which claims the benefit of U.S. Provisional Application No. 62/775,296 entitled “TRACKING MANUFACTURING INFORMATION”, filed on Dec. 4, 2018, both of which are hereby incorporated by reference herein in their entirety.

### BACKGROUND

### 1. Field

Embodiments of this invention relate to tracking manufacturing information and more particularly to tracking manufacturing information by causing the manufacturing information to be stored in a distributed ledger or blockchain.

### 2. Description of Related Art

When a potential customer wishes to have an article, such as a part or device, manufactured by a vendor, it may be difficult to use computer systems to determine which vendor to choose and/or how to expect the manufacturing process to proceed. In particular, where the customer does not have experience with a vendor, it may be difficult to use computer systems to determine how the vendor has performed in the past. Accordingly, computer-aided choice of vendors or manufacturers and scheduling manufacturing can be difficult for customers. Some known computer systems for facilitating manufacturing allow customers to forward designs to manufacturers but do not provide for tracking of manufacturing information or providing manufacturing information to customers. In some computer systems manufacturing information for a customer may be tracked. However, such manufacturing information may be private and available only to the customer.

### SUMMARY

In accordance with various embodiments, there is provided a computer-implemented method of facilitating tracking of manufacturing information for a plurality of manufacturing customers. The method includes causing at least one processor to receive customer defined manufacturing order information associated with a manufacturing order, the customer defined manufacturing order information generated by one of the plurality of manufacturing customers, causing the at least one processor to identify from the customer defined manufacturing order information, non-confidential customer defined manufacturing order information, and causing the at least one processor to produce signals representing the non-confidential customer defined manufacturing order information for causing the non-confidential customer defined manufacturing order information to be transmitted to a plurality of peer computers and stored in a distributed ledger replicated at each of the plurality of peer computers such that the non-confidential customer defined manufacturing order information stored in the plurality of the peer computers is accessible by the plurality of customers. The method also includes causing the at least one processor to receive vendor defined manufacturing order information associated with the manufacturing order, the vendor defined manufacturing order information generated by one of a plurality of manufacturing vendors, causing the at least one processor to identify from the vendor defined manufacturing order information, non-confidential vendor defined manufacturing order information, and causing the at least one processor to produce signals representing the non-confidential vendor defined manufacturing order information for causing the non-confidential vendor defined manufacturing order information to be transmitted to the plurality of peer computers and stored in the distributed ledger such that the non-confidential vendor defined manufacturing order information stored in the plurality of the peer computers is associated with the non-confidential customer defined manufacturing order information and is accessible by the plurality of customers.

The method may further include causing the at least one processor to identify confidential manufacturing order information from the customer defined manufacturing order information, the vendor defined manufacturing order information, or both, causing the at least one processor to generate at least one cryptographic hash value from the confidential manufacturing order information, and causing the at least one processor to produce signals representing the at least one cryptographic hash value for causing the at least one cryptographic hash value to be transmitted to the plurality of peer computers to be stored in the distributed ledger such that the cryptographic hash value is associated with the non-confidential customer defined manufacturing order information and is accessible by the plurality of customers.

Causing the at least one processor to produce the signals representing the non-confidential customer defined manufacturing order information for causing the non-confidential customer defined manufacturing order information to be transmitted to the plurality of peer computers may include causing the at least one processor to produce signals for causing the non-confidential customer defined manufacturing order information to be stored in a first block of the distributed ledger, the first block associated with a first time period. Causing the at least one processor to produce the signals representing the cryptographic hash value for causing the at least one cryptographic hash value to be transmitted to the plurality of peer computers may include causing the at least one processor to produce signals for causing the at least one cryptographic hash value to be stored in the first block of the distributed ledger, such that the first block provides evidence that the non-confidential customer defined manufacturing order information and the at least one cryptographic hash value were stored during the first time period.

Causing the at least one processor to produce the signals representing the non-confidential vendor defined manufacturing order information for causing the non-confidential vendor defined manufacturing order information to be transmitted to the plurality of peer computers may include causing the at least one processor to produce signals for causing at least a portion of the non-confidential vendor defined manufacturing order information to be stored in a second block of the distributed ledger, the second block associated with a second time period subsequent to the first time period.

The customer defined manufacturing order information may include order creation information defining a proposed product order and the vendor defined manufacturing order information may include at least one of estimated order completion information, or order completion information.

The customer defined manufacturing order information may include non-conformance report information and the vendor defined manufacturing order information may include at least one of non-conformance analysis information or non-conformance correction information

In accordance with various embodiments, there is provided a system for facilitating tracking of manufacturing information for a plurality of manufacturing customers including at least one processor configured to perform any method described above.

In accordance with various embodiments, there is provided a non-transitory computer readable medium having stored thereon codes which when executed by at least one processor cause the at least one processor to perform any method described above.

Other aspects and features of embodiments of the invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a computer-implemented system for facilitating tracking of manufacturing information for a plurality of manufacturing customers, according to various embodiments;

FIG. 2 is a schematic view of a tracker of the system shown in FIG. 1 including a processor circuit in accordance with various embodiments;

FIG. 3 is a flowchart depicting blocks of code for directing the tracker of the system shown in FIG. 1 to perform tracking of manufacturing information functions in accordance with various embodiments;

FIG. 4 is a flowchart depicting blocks of code that may be included in the flowchart shown in FIG. 3 in accordance with various embodiments;

FIG. 5 is a representation of a graphical user interface that may be displayed in the system shown in FIG. 1 in accordance with various embodiments;

FIG. 6 is a representation of an exemplary request for quote message that may be used in the system shown in FIG. 1 in accordance with various embodiments;

FIG. 7 is a representation of an exemplary part record that may be used in the system shown in FIG. 1 in accordance with various embodiments;

FIG. 8 is a flowchart depicting blocks of code that may be included in the flowchart shown in FIG. 3 in accordance with various embodiments;

FIG. 9 is a representation of a part summary that may be displayed in the system shown in FIG. 1 in accordance with embodiments;

FIG. 10 is a representation of a graphical user interface that may be displayed in the system shown in FIG. 1 in accordance with various embodiments;

FIG. 11 is a representation of an exemplary vendor quote message that may be used in the system shown in FIG. 1 in accordance with various embodiments;

FIG. 12 is a representation of an exemplary vendor quote record that may be used in the system shown in FIG. 1 in accordance with various embodiments;

FIG. 13 is a representation of a graphical user interface that may be displayed in the system shown in FIG. 1 in accordance with various embodiments;

FIG. 14 is a representation of an exemplary order message that may be used in the system shown in FIG. 1 in accordance with various embodiments;

FIG. 15 is a representation of an exemplary order record that may be used in the system shown in FIG. 1 in accordance with various embodiments;

FIG. 16 is a representation of an exemplary non-confidential order information record that may be used in the system shown in FIG. 1 in accordance with various embodiments;

FIG. 17 is a representation of an updated version of the non-confidential order information record shown in FIG. 16 that may be used in the system shown in FIG. 1 in accordance with various embodiments;

FIG. 18 is a representation of an exemplary ledger order record that may be used in the system shown in FIG. 1 in accordance with various embodiments;

FIG. 19 is a flowchart depicting blocks of code for directing the tracker of the system shown in FIG. 1 to perform tracking of manufacturing information functions in accordance with various embodiments;

FIG. 20 is a representation of a graphical user interface that may be displayed in the system shown in FIG. 1 in accordance with various embodiments;

FIG. 21 is a representation of an exemplary estimated order completion message that may be used in the system shown in FIG. 1 in accordance with various embodiments;

FIG. 22 is a representation of an updated version of the order record shown in FIG. 15 that may be used in the system shown in FIG. 1 in accordance with various embodiments;

FIG. 23 is a representation of an updated version of the ledger order record shown in FIG. 18 that may be used in the system shown in FIG. 1 in accordance with various embodiments;

FIG. 24 is a flowchart depicting blocks of code for directing the tracker of the system shown in FIG. 1 to perform tracking of manufacturing information functions in accordance with various embodiments;

FIG. 25 is a representation of a graphical user interface that may be displayed in the system shown in FIG. 1 in accordance with various embodiments;

FIG. 26 is a representation of an exemplary order completion message that may be used in the system shown in FIG. 1 in accordance with various embodiments;

FIG. 27 is a representation of an updated version of the order record shown in FIG. 22 that may be used in the system shown in FIG. 1 in accordance with various embodiments;

FIG. 28 is a representation of an updated version of the ledger order record shown in FIG. 23 that may be used in the system shown in FIG. 1 in accordance with various embodiments;

FIG. 29 is a flowchart depicting blocks of code for directing the tracker of the system shown in FIG. 1 to perform tracking of manufacturing information functions in accordance with various embodiments;

FIG. 30 is a representation of an exemplary confidential order information record that may be used in the system shown in FIG. 1 in accordance with various embodiments;

FIG. 31 is a representation of an exemplary ledger order record that may be used in the system shown in FIG. 1 in accordance with various embodiments;

FIG. 32 is a flowchart depicting blocks of code for directing the tracker of the system shown in FIG. 1 to perform tracking of manufacturing order non-conformance information functions in accordance with various embodiments;

FIG. 33 is a representation of a graphical user interface that may be displayed in the system shown in FIG. 1 in accordance with various embodiments;

FIG. 34 is a representation of an exemplary non-conformance report generation message that may be used in the system shown in FIG. 1 in accordance with various embodiments;

FIG. 35 is a representation of an exemplary non-conformance report record that may be used in the system shown in FIG. 1 in accordance with various embodiments;

FIG. 36 is a representation of an exemplary non-confidential non-conformance report record that may be used in the system shown in FIG. 1 in accordance with various embodiments;

FIG. 37 is a representation of an exemplary ledger non-conformance report record that may be used in the system shown in FIG. 1 in accordance with various embodiments;

FIG. 38 is a representation of an exemplary non-conformance report analysis message that may be used in the system shown in FIG. 1 in accordance with various embodiments;

FIG. 39 is a representation of an updated version of the non-conformance report record shown in FIG. 35 that may be used in the system shown in FIG. 1 in accordance with various embodiments;

FIG. 40 is a representation of an updated version of the non-confidential non-conformance report record shown in FIG. 36 that may be used in the system shown in FIG. 1 in accordance with various embodiments;

FIG. 41 is a representation of an updated version of the ledger non-conformance report record shown in FIG. 37 that may be used in the system shown in FIG. 1 in accordance with various embodiments;

FIG. 42 is a representation of an updated version of the non-conformance report record shown in FIG. 39 that may be used in the system shown in FIG. 1 in accordance with various embodiments;

FIG. 43 is a representation of an updated version of the non-confidential non-conformance report record shown in FIG. 40 that may be used in the system shown in FIG. 1 in accordance with various embodiments;

FIG. 44 is a representation of an updated version of the ledger non-conformance report record shown in FIG. 41 that may be used in the system shown in FIG. 1 in accordance with various embodiments; and

FIG. 45 is a representation of a quality analytics display that may be displayed in the system shown in FIG. 1 in accordance with various embodiments.

### DETAILED DESCRIPTION

The advent of blockchain and/or distributed ledger technology has provided a previously untapped ability for computer systems to create and provide access to generally immutable and trusted computer databases for storing information. In various embodiments described herein, the general immutability and trustworthiness of distributed ledgers may be leveraged to provide computer-implemented manufacturing information tracking functionality that may accelerate a quality management feedback loop, facilitate continuous improvement of manufacturing, and/or allow customers to make better decisions in having their articles manufactured, such as, for example, decisions regarding vendor selection and/or manufacturing scheduling.

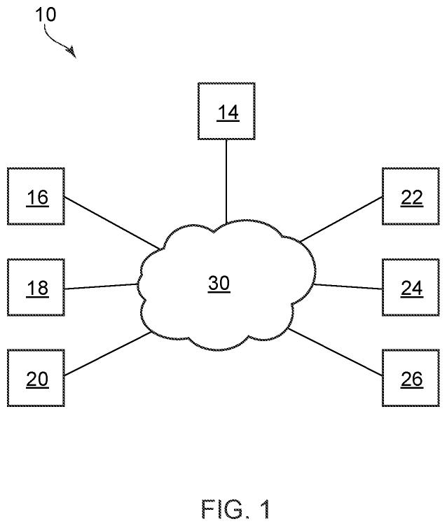

Referring to FIG. 1, there is provided a computer-implemented system 10 for facilitating tracking of manufacturing information for a plurality of manufacturing customers according to various embodiments. The system 10 includes a computer-implemented tracker 14 in communication with customer devices 16, 18, and 20 and vendor devices 22, 24, and 26. In some embodiments, the tracker 14 may be implemented as a computer server, for example, and each of the customer devices 16, 18, and 20, and the vendor devices 22, 24, and 26 may be implemented as computers or computer systems in communication with the tracker 14 via a computer network 30, which may in some embodiments be the Internet, for example. In the embodiment shown in FIG. 1, three vendor devices 22, 24, and 26 and three customer devices 16, 18, and 20 are shown for exemplary purposes only. In various embodiments, generally any number of customer devices and/or vendor devices may be included and/or used in the system 10. In various embodiments, any or all of the tracker 14, the vendor devices 22, 24, and 26 and customer devices 16, 18, and 20 may be in communication with one or more user interfaces which may include a display and/or one or more user input devices for allowing users of the devices to interact with the devices.

In some embodiments, the tracker 14 may act as an intermediary between customers using the customer devices 16, 18, and 20, who wish to have articles (such as parts or devices) manufactured, and vendors using the vendor devices 22, 24, and 26, who are available to manufacture those articles. In various embodiments, a customer may use one of the customer devices 16, 18, and 20 to order the manufacture of parts from one of the vendors and the tracker 14 may facilitate tracking of manufacturing information related to the order, such that non-confidential aspects of the manufacturing information may be later accessed and utilized by other customers. In various embodiments, by allowing other customers to access the non-confidential manufacturing information, these other customers may be able to review such information and make informed decisions regarding their manufacturing strategy, such as, for example, regarding vendor selection and/or manufacturing scheduling.

In various embodiments, the system 10 may be used in global sourcing, supply chain, and quality management platforms, allowing start-ups, small businesses and enterprises to build quality products and scalable supply chains while accessing global quality and performance data. In various embodiments, the system 10 may facilitate collaborative supply chain transparency and thereby improve global manufacturing quality and/or ethical trade.

Referring to FIG. 1, an exemplary embodiment will now be discussed. In various embodiments, a customer may wish to have a part manufactured and so the customer may interact with one or more user interfaces provided by the customer device 16 to cause the customer device 16 to communicate with the tracker 14. For example, in some embodiments, the customer may request one or more graphical user interfaces (“GUIs”), such as for example one or more web pages, from the tracker 14 and the tracker may cause the GUIs to be provided by the customer device 16 to the customer. The GUIs may include fillable forms and/or features for allowing information and/or computer files to be transmitted or uploaded from the customer device 16 to the tracker 14. For example, in some embodiments, the GUIs may facilitate sending of customer defined or derived manufacturing order information to the tracker 14 from the customer device 16. In some embodiments, the customer defined manufacturing order information may include information related to or required for manufacturing an article, such as a part or device. In some embodiments, the customer defined manufacturing order information may include any or all of the following, for example:
Customer identifier
Order identifier
Part creation date
Part last modified date
Part number
Part revision
Part name
Part description
Drawings
Image or avatar representing the part
Customer priority ranking of what is most important of: Fast, Quality, and Price
Build type for the part
Material
One or more proposed quantities of the part to be ordered
Vendor identifier for identifying the vendor to manufacture the part
Date ordered
Order quantity
Purchase order document
Purchase order number
Price per unit of product ordered
Order cost before tax
Applicable taxes
Total order cost
Reorder status
Tooling only information

In various embodiments, the customer defined manufacturing order information may not all be sent at one time. For example, in some embodiments, it may require more than one step for the customer to send/provide the customer defined manufacturing order information. In some embodiments, the customer may first send information required to get a quote from a vendor and next the customer may provide order information including, for example, quantity information and a vendor identifier, to confirm the order based on a quote received from the vendor.

Referring back to FIG. 1, the tracker 14 may be configured to receive customer defined manufacturing order information associated with a manufacturing order, the customer defined manufacturing order information generated by one of the plurality of manufacturing customers. For example, in some embodiments, the tracker 14 may be configured to receive the above-noted customer defined manufacturing order information from the customer device 16 via the network 30 through the provision of one or more web pages.

In some embodiments, the tracker 14 may send some or all of the customer defined manufacturing order information to one or more of the vendor devices 22, 24, and 26 so that a vendor controlling a vendor device may use the customer defined manufacturing order information to begin manufacturing. In some embodiments, for example, where the customer defined manufacturing order information includes a vendor identifier, the tracker 14 may be configured to send a message including some of the customer defined manufacturing order information to one of the vendor devices that corresponds to the vendor identifier, such that the vendor controlling that vendor device can begin manufacturing.

In various embodiments, the tracker 14 may identify from the received customer defined manufacturing order information, non-confidential customer defined manufacturing order information. For example, in some embodiments, the tracker 14 may identify the following as non-confidential customer defined manufacturing order information:
Vendor ID, which may in some embodiments be a unique identifier of the supplier/vendor
Order identifier
Order date
Quantity of parts ordered
Reorder status
Tooling only information

In various embodiments, because the tracker 14 identifies a subset of the customer defined manufacturing order information as non-confidential, the tracker 14 may be able to publish or share this information among customers to help customers make future manufacturing decisions.

The tracker 14 may produce signals representing the non-confidential customer defined manufacturing order information for causing the non-confidential customer defined manufacturing order information to be transmitted to a plurality of peer computers and stored in a distributed ledger replicated at each of the plurality of peer computers such that the non-confidential customer defined manufacturing order information stored in the plurality of the peer computers is accessible by the plurality of customers. For example, in some embodiments, the vendor devices 22, 24, and 26, or other devices controlled by one or more of the vendors, may act as the peer computers and the tracker 14 may send the non-confidential customer defined manufacturing order information to the vendor devices 22, 24, and 26 for storage in a distributed ledger. In some embodiments, a blockchain software package or system such as, for example, as provided by Hyperledger™, may be implemented by the tracker 14 and each of the vendor devices 22, 24, and 26 to facilitate storage of the non-confidential customer defined manufacturing order information in a distributed ledger or blockchain replicated at each of the vendor devices.

In various embodiments, by causing the non-confidential customer defined manufacturing order information to be stored in a distributed ledger that may be held by various parties of competing interests, for example, such as, the vendor devices 22, 24, and 26, the tracker 14 may facilitate the non-confidential customer defined manufacturing order information being generally trusted and/or immutable. In some embodiments, by causing the non-confidential customer defined manufacturing order information to be stored in a distributed ledger, the tracker 14 may facilitate easy access of the non-confidential customer defined manufacturing order information by other customers.

In some embodiments, information stored in the distributed ledger may be associated with temporal information. For example, in some embodiments, where the distributed ledger is a blockchain, the information stored in the distributed ledger may be stored as a temporally ordered set of blocks and it may be extremely difficult to re-order the blocks to change the temporal association. Accordingly, in some embodiments, by using a distributed ledger to store information, the information may be associated with a time period in a trusted way, such as, for example, through its inclusion in a particular block. In various embodiments, this temporal association may be desired by customers later accessing the manufacturing information, as it may provide evidence to the customer that the information is trustworthy and has not been tampered with.

In some embodiments, the vendor and/or the vendor device may generate vendor defined or derived manufacturing order information associated with the manufacturing order. For example, in some embodiments, as discussed above, after receiving the customer defined manufacturing order information, the tracker 14 may have sent at least a portion of the customer defined manufacturing order information to one of the vendor devices 22, 24, and 26 to cause the vendor device to provide a GUI to allow the vendor to provide vendor defined quote information, which may act as vendor defined manufacturing order information. In various embodiments, the vendor defined quote information may include:
Quoted price per unit for manufacturing at least one quantity of the part
Quoted lead time for completing samples and shipping the samples from manufacturer
Quoted lead time for completing production and shipping from manufacturer
Tooling setup charges
Number of samples to be provided
Harmonized code for the part
Quote document
Shipping country of origin
Shipping dimensions
Shipping weight
Number of parts per shipping unit or box

The vendor device may cause the vendor defined quote information to be sent to the tracker 14. In some embodiments, the vendor defined quote information may be sent to the tracker 14 via the network 30, for example. In some embodiments, upon receiving confirmation of the order from the tracker 14, the vendor may provide further vendor defined manufacturing order information, which may include vendor defined estimated completion date information, such as, for example:
Estimated completion date for production run to be shipped from manufacturer

In various embodiments, the tracker 14 may receive vendor defined manufacturing order information associated with the manufacturing order, the vendor defined manufacturing order information generated by one of a plurality of manufacturing vendors. For example, in some embodiments, the tracker 14 may receive the vendor defined quote information and the vendor defined estimated completion date information from the vendor device 22 via the network 30, for example.

The tracker 14 may then identify from the vendor defined manufacturing order information, non-confidential vendor defined manufacturing order information. For example, in some embodiments, the tracker 14 may identify the following as non-confidential vendor defined manufacturing order information:
Quoted lead time for completing samples and shipping the samples from manufacturer
Quoted lead time for completing production and shipping from manufacturer
Estimated completion date for production run to be shipped from manufacturer (estimated after order placed)

In various embodiments, by identifying a subset of the vendor defined manufacturing order information as non-confidential, the tracker 14 may be able to publish or provide access to this information for customers of the system 10.

In various embodiments, the tracker 14 may produce signals representing the non-confidential vendor defined manufacturing order information for causing the non-confidential vendor defined manufacturing order information to be transmitted to the plurality of peer computers and stored in the distributed ledger such that the non-confidential vendor defined manufacturing order information stored in the plurality of the peer computers is associated with the non-confidential customer defined manufacturing order information and is accessible by the plurality of customers. For example, in some embodiments, the tracker 14 may send the non-confidential vendor defined manufacturing order information with the non-confidential customer defined manufacturing order information for storage in a distributed ledger.

In various embodiments, further customer defined manufacturing order information and/or vendor defined manufacturing order information may be received by the tracker 14 and treated generally as described above. For example, in some embodiments, when a vendor completes production of the part and ships the part, the vendor may use a vendor device to send further vendor defined manufacturing order information to the tracker 14 including, for example:
Shipping identifier
Actual completion date when production run shipped out of manufacturer
Carrier name indicating which shipping carrier took the shipment
Carrier assigned tracking number
Unique shipping identifier

In various embodiments, the tracker may identify the actual completion date as non-confidential information and may cause the actual completion date to be stored in the distributed ledger in association with the previously stored non-confidential manufacturing order information.

In some embodiments, the tracker 14 may be configured to track additional or alternative customer defined and vendor defined manufacturing order information. For example, in some embodiments, a customer may determine that a manufacturing order of parts or devices does not conform to their expectations and so may generate and send a non-conformance report to the tracker 14. In various embodiments, the tracker 14 may be configured to track non-conformance information related to the non-conformance report and the manufacturing order, using generally similar steps to those set out above, except that the non-conformance report information acts as the customer defined manufacturing order information and the vendor defined manufacturing order information. In various embodiments, this non-conformance information tracking may be provided independent of any order or quote information tracking.

Tracker—Processor Circuit

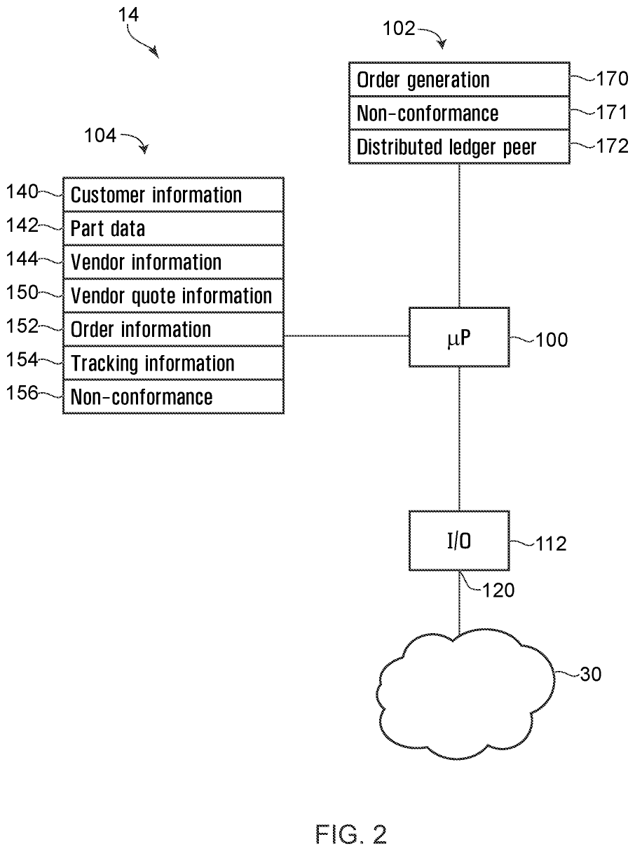

Referring now to FIG. 2, a schematic view of the tracker 14 of the system 10 shown in FIG. 1 according to various embodiments is shown. In various embodiments, the tracker 14 may be implemented as a computer server, for example, which is accessible via the network 30.

Referring to FIG. 2, the tracker 14 includes a processor circuit including a tracker processor 100 and a program memory 102, a storage memory 104, and an input/output (I/O) interface 112, all of which are in communication with the tracker processor 100. In various embodiments, the tracker processor 100 may include one or more processing units or processors, such as for example, a central processing unit (CPU), a graphical processing unit (GPU), and/or a field programmable gate array (FPGA). In some embodiments, any or all of the functionality of the tracker 14 described herein may be implemented using one or more FPGAs.

The I/O interface 112 includes an interface 120 for facilitating networked communication through the network 30, for example, for facilitating communication with the customer devices 16, 18, and 20 and the vendor devices 22, 24, and 26 shown in FIG. 1, for example. In some embodiments, the interface 120 may facilitate a wireless or wired communication. In some embodiments, the I/O interface 112 may include a network interface device or card with an input/output for connecting to the network 30, through which communications may be conducted with devices connected to the network 30. In some embodiments, the network 30 may be a private network to which the tracker 14, the customer devices 16, 18, and 20, and the vendor devices 22, 24, and 26 are connected. In some embodiments the network 30 may be a public network, such as the Internet, for example.

In some embodiments, the interface 120 shown in FIG. 2 may include one or more interfaces and/or may be implemented as a combined interface with another interface.

In some embodiments, where a device is described herein as receiving or sending information, it may be understood that the device receives signals representing the information via an interface of the device or produces signals representing the information and transmits the signals to the other device via an interface of the device.

Processor-executable program codes for directing the tracker processor 100 to carry out various functions are stored in the program memory 102. Referring to

FIG. 2, the program memory 102 includes a block of codes 170 for directing the tracker processor 100 to perform tracking of manufacturing order generation information functions, a block of codes 171 for directing the tracker processor 100 to perform tracking of manufacturing order non-conformance information functions and a block of codes 172 for directing the tracker processor 100 to perform distributed ledger functions. In this specification, it may be stated that certain encoded entities such as applications or modules perform certain functions. Herein, when an application, module or encoded entity is described as taking an action, as part of, for example, a function or a method, it will be understood that at least one processor (e.g., the tracker processor 100) is directed to take the action by way of programmable codes or processor-executable codes or instructions defining or forming part of the application.

The storage memory 104 includes a plurality of storage locations including location 140 for storing customer information, location 142 for storing part information, location 144 for storing vendor information, location 150 for storing vendor quote information, location 152 for storing order information, location 154 for storing tracking information, and location 156 for storing non-conformance information. In various embodiments, the plurality of storage locations may be stored in a database in the storage memory 104.

In various embodiments, any or all of the blocks of code 170, 171, and 172 may be integrated into a single block of codes or portions of any or all of the blocks of code 170, 171, and 172 may include one or more blocks of code stored in one or more separate locations in the program memory 102. In various embodiments, any or all of the locations 140, 142, 144, 150, 152, 154, and 156 may be integrated and/or each may include one or more separate locations in the storage memory 104.

Each of the program memory 102 and storage memory 104 may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 102, the storage memory 104, and/or any portion thereof may be included in a device separate from the tracker 14 and in communication with the tracker 14 via the I/O interface 112, for example.

In various embodiments, other device components described herein, such as memory, program memory, blocks of code, storage memory, locations in memory, and/or I/O interfaces, may be implemented generally similarly to as described above for the tracker 14.

Tracking Manufacturing Order Generation Information

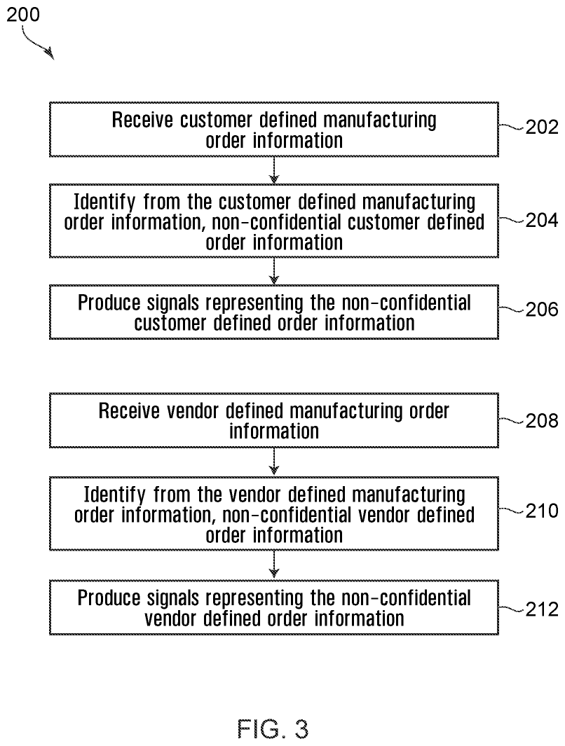

Referring now to FIG. 3, a flowchart depicting blocks of code for directing the tracker processor 100 shown in FIG. 2 to perform tracking of manufacturing information functions in accordance with various embodiments is shown generally at 200. In various embodiments, the blocks of code included in the flowchart 200 may direct the tracker processor 100 to facilitate tracking of manufacturing order generation information for a plurality of manufacturing customers. The blocks of code included in the flowchart 200 may be encoded in the block of codes 170 of the program memory 102 shown in FIG. 2 for example.

Referring to FIG. 3, the flowchart 200 includes blocks 202, 204 and 206 for directing the tracker processor 100 to process or track customer defined manufacturing order information and blocks 208, 210, and 212 for directing the tracker processor 100 to process or track vendor defined manufacturing order information. In various embodiments, blocks 202, 204, and 206 may be executed concurrently and/or separately from blocks 208, 210, and 212.

Referring to FIG. 3, in some embodiments, the flowchart 200 may begin with block 202 which directs the tracker processor 100 shown in FIG. 2 to receive customer defined manufacturing order information associated with a manufacturing order, the customer defined manufacturing order information generated by one of the customers. For example, in some embodiments, referring to FIG. 1, a customer may use the customer device 16 to communicate with the tracker 14 via the network 30 and provide the customer defined manufacturing order information.

In some embodiments, block 202 may direct the tracker processor 100 to receive a request for quote (“RFQ”) message which defines aspects of the part the customer wishes to have manufactured and then to later receive an order message defining an order which the customer wishes to make. Information included in both the RFQ message and the order message may act as customer defined manufacturing order information received at block 202.

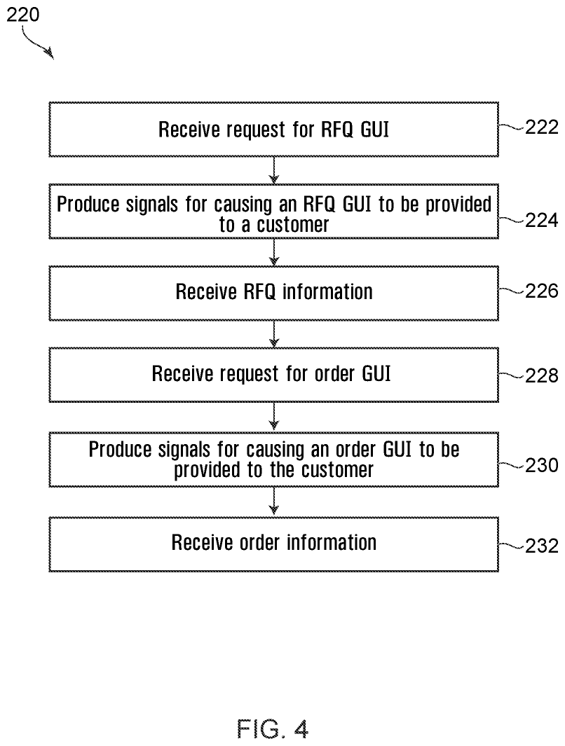

Referring now to FIG. 4, there is shown a flowchart 220 depicting blocks of code that may be included in the block 202 of the flowchart 200 shown in FIG. 3. The flowchart 220 includes blocks of code for directing the tracker processor 100 to perform customer defined manufacturing order information receiving functions in accordance with various embodiments.

In various embodiments, the flowchart 220 may be initiated by a customer using one of the customer devices 16, 18, and 20. For example, in some embodiments, a customer using the customer device 16 may wish to have a part manufactured and so the customer may use a web browser of the customer device 16 to communicate with the tracker 14 to initiate manufacturing of the part. In some embodiments, the customer may wish to first receive a quote for costs of manufacturing the part and so the customer may use the web browser to send to the tracker 14, via the network 30, a web request for a web page or web browser based GUI, which the customer can use to prepare an RFQ.

The flowchart 220 begins with block 222 which directs the tracker processor 100 to receive a request for an RFQ graphical user interface (“GUI”). As discussed above, in various embodiments, the customer device 16 may send a web request for a web browser based GUI which the customer can use to prepare an RFQ. Accordingly, in some embodiments, block 222 may direct the tracker processor 100 to receive the web request from the customer device 16 via the interface 120 of the I/O interface 112 and the network 30 shown in FIG. 2.

In some embodiments, block 222 may include code for directing the tracker processor 100 to provide login functionality for the customer device 16 such that customer information associated with the customer may be identified or received and stored in the location 140 of the storage memory 104. In various embodiments, the customer information may include a unique customer identifier, customer name, and/or shipping information such as a shipping address for the customer, for example.

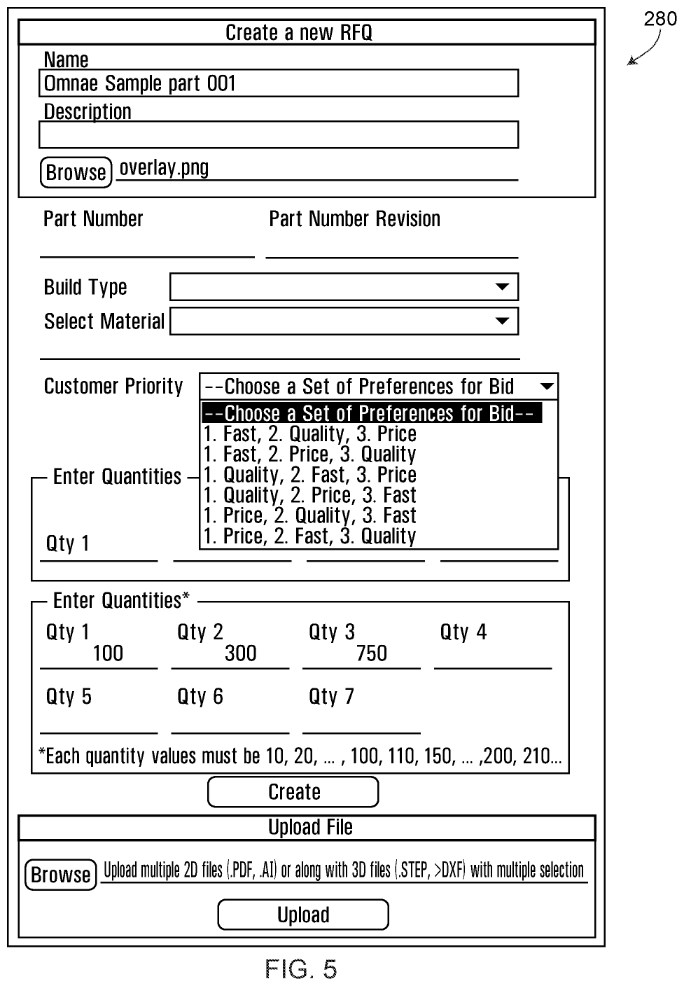

Block 224 then directs the tracker processor 100 to produce signals for causing an RFQ GUI to be displayed or provided to a customer. In various embodiments, block 224 may direct the tracker processor 100 to transmit signals to the customer device 16 via the interface 120 of the I/O interface 112 and the network 30 shown in FIG. 2 for causing a GUI, such as, for example, a web browser based RFQ GUI 280 as shown in FIG. 5, to be displayed by a display of the customer device 16. In various embodiments, the GUI 280 includes fillable forms and/or features for allowing information and/or computer files to be transmitted or uploaded from the customer device 16 to the tracker 14.

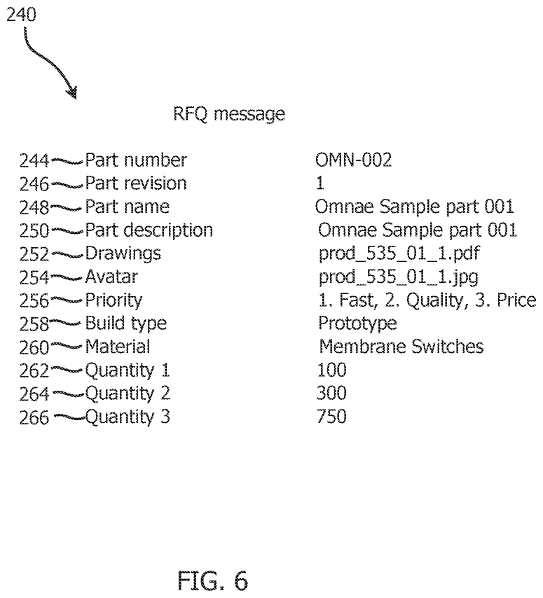

In some embodiments, the customer may use the customer device 16 to interact with the web browser based RFQ GUI 280 to provide information and cause the customer device 16 to transmit an RFQ message, an exemplary one of which is shown at 240 in FIG. 6, to the tracker 14.

Referring to FIG. 6, the RFQ message 240 includes a part number field 244 for storing a part number provided by the customer for the part, a part revision field 246 for storing a revision number associated with the part as provided by the customer, a part name field 248 for storing a part name provided by the customer, a part description field 250 for storing a part description provided by the customer, and a drawings field 252 for storing one or more 2D and/or 3D drawings or representations of the part which the customer wishes to have manufactured. In some embodiments, the drawings field 252 may include a 2D drawing, such as a .pdf or .ai type drawing, and/or a 3D drawing or model, such as a .step or .dxf type drawing, for example.

In various embodiments, the RFQ message 240 may also include an avatar or image field 254 for storing a representative image of the part or device as provided by the customer, a priority field 256 for storing a representation of a ranking of what is most important to the customer regarding speed, quality, and price for the part, and a build type field 258 for storing a build type for the part or device, which may, in some embodiments be chosen from prototype, production, both, or assembly, for example.

In various embodiments, the RFQ message 240 may also include a material type field 260 for storing a material type for the part or device and one or more quantity fields 262, 264, and 266 for storing various quantities for which the customer wishes to receive a price quote.

Referring back to FIG. 4, block 226 directs the tracker processor 100 to receive RFQ information. In various embodiments, block 226 may direct the tracker processor 100 to receive a representation of the RFQ message 240 shown in FIG. 6, for example, from the customer device 16 via the interface 120 of the I/O interface 112 and the network 30 shown in FIG. 2.

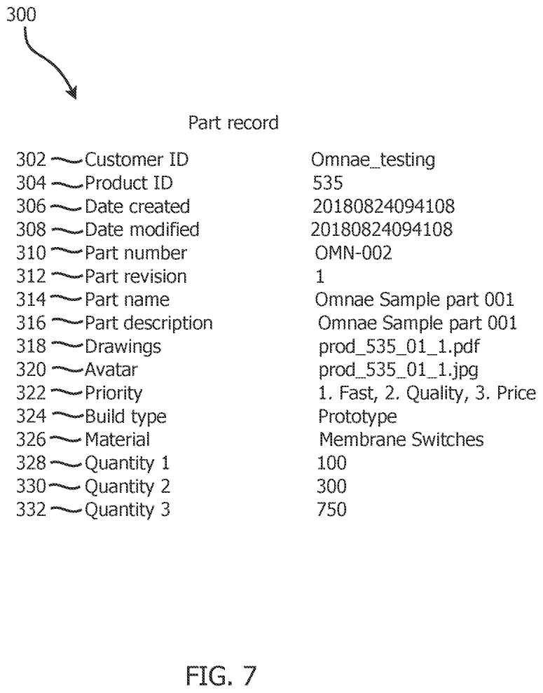

Block 226 may direct the tracker processor 100 to generate a part record 300 as shown in FIG. 7 and to store information from the RFQ message in the part record 300 in the location 142 of the storage memory 104 shown in FIG. 2. In some embodiments, block 226 may direct the tracker processor 100 to retrieve a customer identifier from the location 140 of the storage memory 104 and to store the customer identifier in a customer identifier field 302 of the part record 300. In some embodiments, block 226 may direct the tracker processor 100 to generate and store a unique product identifier in a product identifier field 304 of the part record 300 to facilitate unique identification of the part associated with the part record 300.

In various embodiments, block 226 may direct the tracker processor 100 to generate and store representations of dates in a date created field 306 and a date modified field 308 in the part record 300 to facilitate tracking of when the part record was created and when it was last modified. In various embodiments, block 226 may direct the tracker processor 100 to fill in the part number field 310, part revision field 312, part name field 314, part description field 316, drawings field 318, avatar field 320, priority field 322, build type field 324, material field 326, and quantity fields 328, 330, and 332 with the information from corresponding fields in the RFQ message 240 shown in FIG. 6.

In various embodiments, information included in the part record 300 shown in FIG. 7 may act as customer defined manufacturing order information.

In various embodiments, after block 226 has been executed, the customer may wait for quote information to be provided by a vendor before proceeding with providing order information. Accordingly, in various embodiments, after block 226 of the flowchart 220 has been executed and before block 228 is executed, block 208 of the flowchart 200 shown in FIG. 4 may be executed and vendor defined quote information may be received by the tracker 14.

Referring to FIG. 3, block 208 directs the tracker processor 100 to receive vendor defined manufacturing order information, the vendor defined manufacturing order information generated by one of a plurality of manufacturing vendors. In some embodiments, a vendor using one of the vendor devices 22, 24, and 26 may communicate with the tracker 14 via the network 30 and provide the vendor defined manufacturing order information. In some embodiments, block 208 may direct the tracker processor 100 to send some of the order information included in the part record 300 to one of the vendor devices, such as the vendor device 22, for example, and to receive quote information from the vendor device 22, representing the vendor's quote for fulfilling an order represented by the order information.

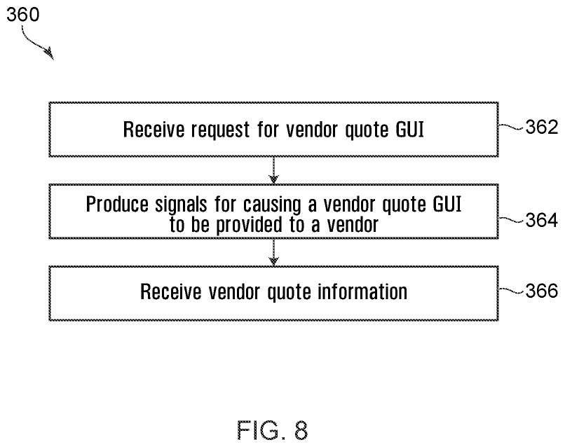

Referring to FIG. 8, there is shown a flowchart 360 depicting blocks of code that may be included in the block 208 of the flowchart 200 shown in FIG. 3, in various embodiments. The flowchart 360 includes blocks of code for directing the tracker processor 100 to perform vendor defined manufacturing order information receiving functions in accordance with various embodiments.

In various embodiments, the flowchart 360 may be initiated by a vendor using one of the vendor devices 22, 24, or 26. For example, in some embodiments, a vendor using the vendor device 22 may wish to manufacture a part for which a request for quote was submitted by the customer and so the vendor may use a web browser of the vendor device 22 to communicate with the tracker 14 and provide a quote for manufacturing of the part. In some embodiments, the vendor may use the web browser to send to the tracker 14, via the network 30, a web request for a web page or web browser based GUI, which the vendor can use to review RFQs for parts that have been submitted to the tracker 14 by customers. In some embodiments, the tracker 14 may be configured to control which RFQs are accessible by each particular vendor.

The flowchart 360 begins with block 362 which directs the tracker processor 100 to receive a request for a vendor quote GUI from a vendor device. In various embodiments, the vendor device 22 may send a web request for a web browser based vendor quote GUI which the vendor can use to review RFQs and provide quotes. Accordingly, in some embodiments, block 362 may direct the tracker processor 100 to receive a web request from the vendor device 22 via the interface 120 of the I/O interface 112 and the network 30 shown in FIG. 2.

In some embodiments, block 362 may include code for directing the tracker processor 100 to provide login functionality for the vendor device 22 such that vendor information associated with the vendor may be identified or received and stored in the location 146 of the storage memory 104. In various embodiments, the vendor information may include, for example, a vendor identifier for uniquely identifying the vendor, a vendor name and/or shipping information such as a shipping address for the customer, for example.

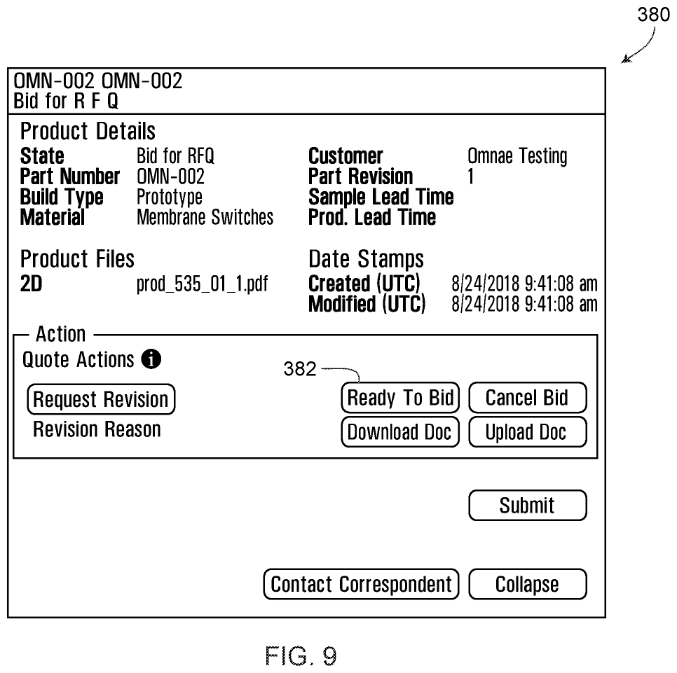

Block 364 then directs the tracker processor 100 to produce signals for causing one or more vendor quote GUIs to be provided to the vendor. In some embodiments, block 364 may direct the tracker processor 100 to produce signals for causing RFQ information to be displayed or provided to the vendor. In some embodiments, block 364 may direct the tracker processor 100 to transmit some of the information from the part record 300 stored in the location 142 of the storage memory 104 to the vendor device 22 such that the vendor using the vendor device 22 can review the order information to prepare quote information. For example, in some embodiments, block 364 may direct the tracker processor 100 to transmit a representation of the information included in the part record 300 shown in FIG. 7 to the vendor device 22 to cause a display of the vendor device to display a part summary 380 as shown in FIG. 9.

The vendor may review the information shown in the part summary 380 and, if the vendor wishes to provide a quote, select the “Ready To Bid” icon 382 to cause the vendor device 22 to transmit a web request for a vendor quote GUI to the tracker 14.

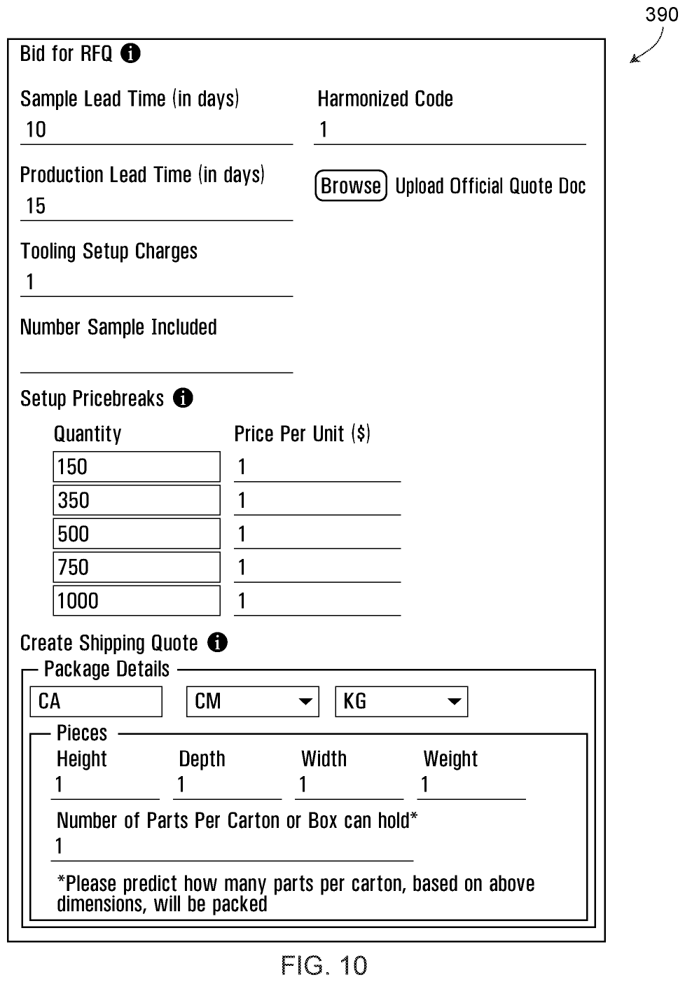

Block 364 may then direct the tracker processor 100 to receive the request for a vendor quote GUI from the vendor device 22 via the interface 120 of the I/O interface 112 and the network 30 shown in FIG. 2. In response to receiving the request, block 364 may direct the tracker processor 100 to transmit signals to the vendor device 22 via the interface 120 of the I/O interface 112 and the network 30 shown in FIG. 2 for causing a vendor quote GUI, such as, for example, a web browser based vendor quote GUI 390 as shown in FIG. 10, to be displayed by the display of the vendor device 22. In various embodiments, the vendor quote GUI 390 may include fillable forms and/or features for allowing information and/or computer files to be transmitted or uploaded from the vendor device 22 to the tracker 14.

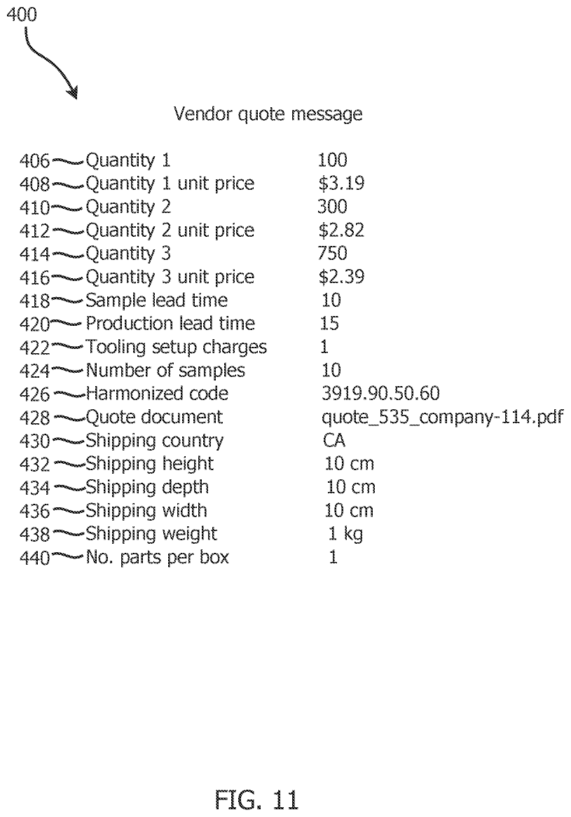

The vendor may interact with the vendor quote GUI 390 to cause the vendor device 22 to transmit a vendor quote message 400 as shown in FIG. 11 to the tracker 14. Referring to FIG. 11, the vendor quote message 400 may include price per unit quote information, indicating costs for manufacturing the part. In some embodiments, the vendor quote message 400 may include a plurality of price per unit quotes, each associated with a quantity. For example, in various embodiments, the vendor quote message may include quantity fields 406, 410, and 414 and associated price per unit fields 408, 412, and 416. Each quantity field and associated price per unit field may store information that represents a price break at which the vendor would be able to manufacture the part. In various embodiments, as quantity increases, the price per unit may go down.

The vendor quote message 400 may include vendor defined estimates of time required to perform certain manufacturing acts. For example, in some embodiments, the vendor quote message 400 shown in FIG. 11 may include an estimated sample lead time field 418 for storing an estimated time in days the vendor expects will be required to produce a sample part for the customer and a production lead time field 420 for storing an estimated time in days the vendor expects will be required to produce a production quality part for the customer.

In various embodiments, the vendor quote message may include a tooling setup charges field 422 for storing an amount the vendor will charge for tooling setup. In various embodiments, the amount of tooling setup charge may vary and could, for example be between about $10 to about $100,000, depending on the type and complexity of the product., The vendor quote message may also include a number of samples field 424 for storing a number of samples the vendor will provide, a harmonized code field 426 for storing a harmonized code for classifying the part, and a quote document field 428 for storing an official quote document provided by the vendor (e.g., a .pdf file).

Referring to FIG. 11, the vendor quote message 400 may also include shipping information provided by the vendor, which may set out how the samples and/or production parts may be sent to the customer. For example, referring to FIG. 11, the vendor quote message may include a shipping country field 430 for storing a representation of a shipping origin for the part, shipping height, depth, width, and weight fields 432, 434, 436, and 438 for storing values representing the height, depth, width, and weight of a shipment including the part, and a number of parts per box field 440 for storing a number of parts that would be included in each box having the properties defined by the fields 432, 434, 436, and 438. In various embodiments, this information may be used by the customer, tracker 14, or vendor to determine or calculate shipping costs for the part.

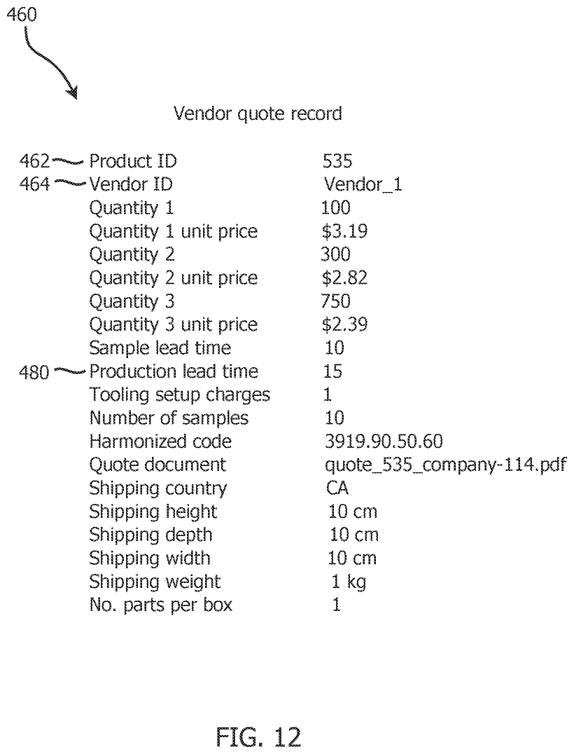

Referring back to FIG. 8, in various embodiments, block 366 may direct the tracker processor 100 to receive vendor quote information. For example, in some embodiments, block 366 may direct the tracker processor 100 to receive the vendor quote message 400 shown in FIG. 11 from the vendor device 22 via the interface 120 of the I/O interface 112 and the network 30 shown in FIG. 2. In various embodiments, block 366 may direct the tracker processor 100 to store the vendor quote information in association with the part to which the information applies. In some embodiments, for example, block 366 may direct the tracker processor 100 to generate a vendor quote record 460 as shown in FIG. 12, including a product identifier field 462 for storing a product identifier to associate the vendor quote record with the part record 300, and a vendor identifier field 464 for storing a vendor identifier that is unique to the vendor that provided the vendor quote information.

In some embodiments, block 366 may direct the tracker processor 100 to retrieve the product identifier for the product identifier field 462 from the part record 300 stored in the location 142 of the storage memory 104 shown in FIG. 2 and to retrieve the vendor identifier for the vendor identifier field 464 from the vendor information stored in the location 144 of the storage memory. Block 366 may direct the tracker processor 100 to include the information and fields from the vendor quote message 400 in the vendor quote record 460 as shown in FIG. 12. In various embodiments, block 366 may direct the tracker processor 100 to store the vendor quote record 460 in the location 150 of the storage memory 104. In various embodiments, information included in the vendor quote record 460 shown in FIG. 12 may be vendor quote information which may act as vendor defined manufacturing order information.

In various embodiments, after block 366 of the flowchart 360 shown in FIG. 8 has been completed and the vendor quote information has been received, this may complete block 208 of the flowchart 200 shown in FIG. 3.

In various embodiments, after block 366 of the flowchart 360 shown in FIG. 8 has been completed, execution of block 202 of the flowchart 200 shown in FIG. 3 may resume. For example, in some embodiments, block 228 of the flowchart 220 shown in FIG. 4 may be executed after block 366 of the flowchart 360 has been executed.

Referring to FIG. 4, block 228 directs the tracker processor 100 to receive a request for an order GUI. In various embodiments, a customer using the customer device 16 may have used their web browser to transmit a request for an order GUI to allow the customer to make an order of the part defined by the part record 300. Block 228 may direct the tracker processor 100 to receive the request from the customer device 16 via the interface 120 and the network 30, for example.

Block 230 then directs the tracker processor 100 to produce signals for causing an order GUI to be provided to the customer. In some embodiments, block 230 may direct the tracker processor 100 to retrieve the vendor quote information from the location 150 of the storage memory 104 shown in FIG. 2 and to transmit some of the vendor quote information to the customer device 16 for causing the customer device to display the vendor quote information. For example, in some embodiments, block 230 may direct the tracker processor 100 to retrieve the vendor quote record 460 from the location 150 of the storage memory and to transmit signals representing information from the vendor quote record 460 to the customer device 16 for causing an order GUI 520 as shown in FIG. 13 to be displayed by the display of the customer device 16.

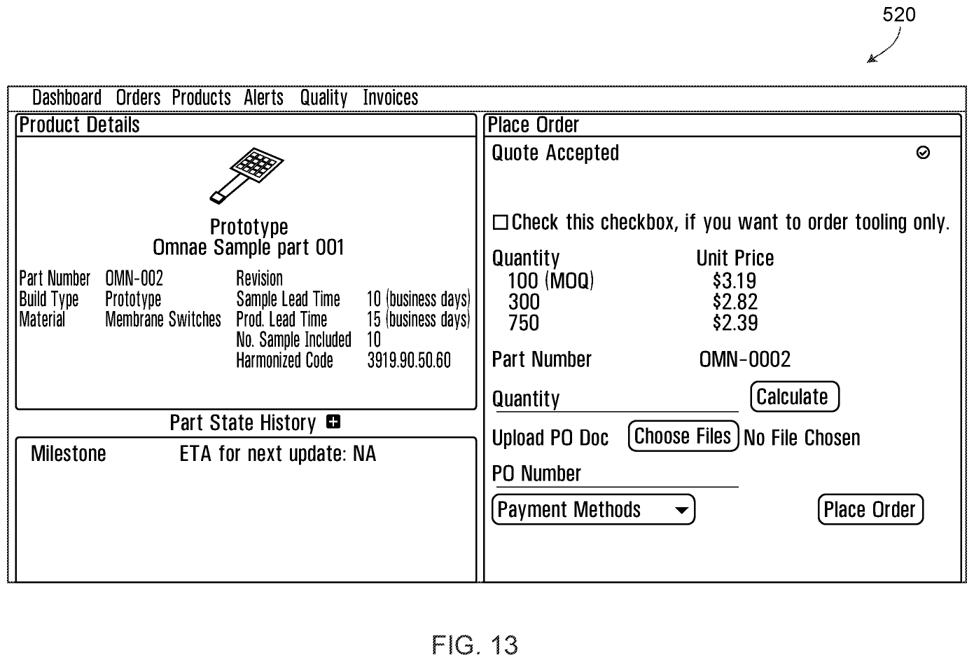

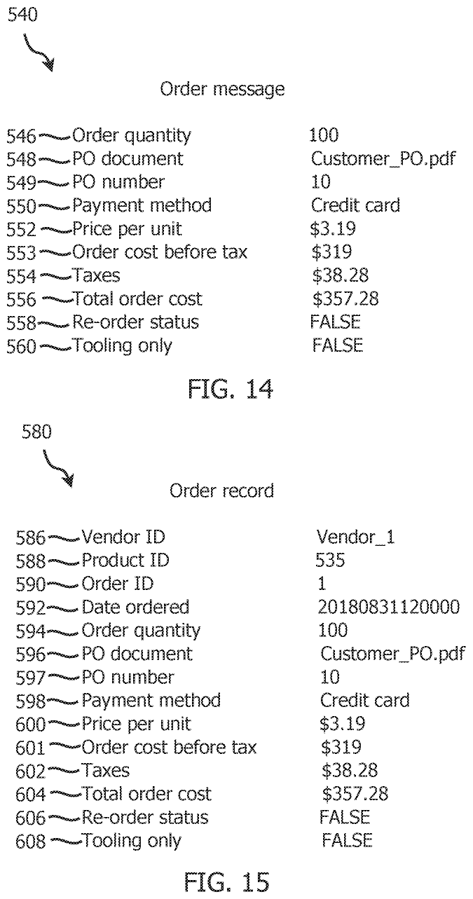

In various embodiments, the customer may review the information provided in the GUI 520 and determine that they wish to make an order. Accordingly, the customer may interact with the order GUI 520 using the customer device 16, to cause the customer device 16 to transmit order information to the tracker 14. For example, in some embodiments, the customer may interact with the order GUI 520 using the customer device 16, to cause the customer device 16 to transmit an order message 540 as shown in FIG. 14 to the tracker 14 via the network 30.

Referring to FIG. 14, the order message 540 includes an order quantity field 546 for storing a quantity of the part that the customer wishes to order, a PO document field 548 for storing a customer provided purchase order document, a PO number field 549 for storing a customer provided reference number for the purchase order to be used with the order, and a payment method field 550 for storing a representation of the method of payment that the customer wishes to use. In some embodiments, for example, the values stored in the payment method field 550 may represent one of a plurality of options, such as, for example, “Credit Card”, “Cheque”, or “Wire”. In various embodiments, the order message 540 also includes a price per unit field 552 for storing a price per unit of the quantity ordered, an order cost before tax field 553 for storing an order cost before tax for the order, a taxes field 554 for storing the amount of tax to be charged for the order, and a total order cost field 556 for storing the total cost of the order. In various embodiments, the customer device 16 may be configured to automatically set the values of the price per unit field 552, order cost before tax field 553, taxes field 554, and total order cost field 556 based on the vendor quote information, the quantity provided by the customer, and customer and vendor address information, for example.

In various embodiments, the order message 540 may also include a re-order status field 558 for storing an indicator of whether the order is a re-order. In various embodiments, where the customer is using the customer device 16 to make a re-order of an order already previously made, the customer device 16 may set the re-order status field 558 to TRUE, whereas for an order that is a new order, the field 558 may be set to FALSE.

In various embodiments, the order message 540 may also include a tooling only field 560 for storing an indicator of whether the order is for tooling and samples only and not for a production run, such that the quantity ordered would be 0. In various embodiments, the customer may provide an indication of whether the order is for tooling only using the GUI 520.

Referring to FIG. 4, block 232 directs the tracker processor 100 to receive order information. In various embodiments, block 232 may direct the tracker processor 100 to receive the order message 540 from the customer device 16. Block 232 may direct the tracker processor 100 to generate and store an order record 580 as shown in FIG. 15 that includes the received order information in fields 594, 596, 597, 598, 600, 601, 602, 604, 606, and 608 of the order record 580. In various embodiments, block 232 may direct the tracker processor 100 to include in the order record 580, a vendor identifier field 586 and a product identifier field 588 for associating the order record with the applicable vendor, part record, and vendor quote record. In some embodiments, block 232 may direct the tracker processor 100 to generate and include an order identifier field 590 for storing a unique order identifier for the order record 580. In some embodiments, block 232 may direct the tracker processor 100 to generate and store a representation of the date and time that the order was made by the customer in a date ordered field 592 of the order record 580.

In various embodiments, block 232 may direct the tracker processor 100 to store the order record 580 in the location 152 of the storage memory 104. In various embodiments, information included in the order record 580 may act as customer defined manufacturing order information. In various embodiments completing execution of block 232 may complete execution of block 202 shown in FIG. 3.

Referring to FIG. 3, after block 202 has been executed, customer defined manufacturing order information may be stored in the storage memory 104 and may include information included in the part record 300 stored in the location 142 of the storage memory 104 and information included in the order record 580 stored in the location 152 of the storage memory 104 shown in FIG. 2, for example.

Referring to FIG. 3, block 204 then directs the tracker processor 100 to identify from the customer defined manufacturing order information, non-confidential customer defined manufacturing order information. In various embodiments, block 204 may direct the tracker processor 100 to identify information from the part record 300 stored in the location 142 and/or from the order record 580 stored in the location 152 of the storage memory 104 as non-confidential information. In some embodiments, block 204 may direct the tracker processor 100 to identity a subset of the customer defined manufacturing order information as non-confidential. In some embodiments, a definition of which fields included in the part record 300 and order record 580 include non-confidential information may be hardcoded in the block of codes 204. In various embodiments, by identifying which of the customer defined manufacturing order information is non-confidential, the tracker processor 100 may be able to allow access to the information, to third parties, such as other customers, for their benefit.

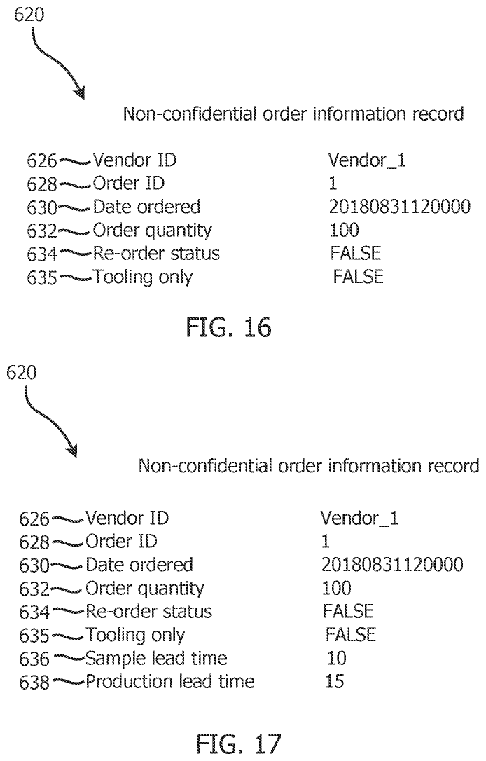

In some embodiments, block 204 may direct the tracker processor 100 to generate a non-confidential order information record 620 as shown in FIG. 16 including a vendor identifier field 626, an order identifier field 628, a date ordered field 630, an order quantity field 632, a re-order status field 634, and a tooling only field 635 and to store the record 620 in the location 154 of the storage memory 104 shown in FIG. 2. Block 204 may direct the tracker processor 100 to copy values from corresponding fields in the order record 580 into the fields 626, 628, 630, 632, 634, and 635 of the non-confidential order information record 620 shown in FIG. 16. In various embodiments, block 204 may direct the tracker processor 100 to also or alternatively include values from fields in the part record 300 in the non-confidential order information record 620. For example, in some embodiments, information from the build type field 324 and/or the material field 326 of the part record 300 shown in FIG. 7 may be included in the non-confidential order information record 620.

Referring to FIG. 3, in some embodiments, block 210 of the flowchart 200 may be executed generally concurrently with block 204. Block 210 directs the tracker processor 100 to identify from the vendor defined manufacturing order information, non-confidential vendor defined manufacturing order information. In various embodiments, block 210 may direct the tracker processor 100 to identify information from the vendor quote record 460 stored in the location 150 of the storage memory 104 as non-confidential information. In some embodiments, block 204 may direct the tracker processor 100 to identity a subset of the vendor defined manufacturing order information as non-confidential. In some embodiments, a definition of which fields included in the vendor quote record 460 include non-confidential information may be hardcoded in the block of code 210. In various embodiments, by identifying which of the vendor defined manufacturing order information is non-confidential, the tracker processor 100 may be able to allow access to the information to third parties, such as customers, for their benefit.

In some embodiments, block 210 may direct the tracker processor 100 to add fields for storing non-confidential vendor defined manufacturing order information to the non-confidential order information record 620. For example, referring to FIG. 17, in some embodiments, block 210 may direct the tracker processor 100 to add a sample lead time field 636 and a production lead time field 638 to the non-confidential order information record 620 stored in the location 154 of the storage memory 104 shown in FIG. 2. Block 210 may direct the tracker processor 100 to copy the sample lead time and production lead time from the vendor quote record 460 into the sample lead time field 636 and the production lead time field 638 respectively of the record 620 shown in FIG. 17.

Referring back to FIG. 3, after blocks 206 and 210 have completed, the non-confidential order information record 620 as shown in FIG. 17 may be stored in the location 154 of the storage memory 104 shown in FIG. 2. The non-confidential order information record 620 may act as information identified as non-confidential at blocks 204 and 210.

Block 206 directs the tracker processor 100 to produce signals representing the non-confidential customer defined manufacturing order information for causing the non-confidential customer defined manufacturing order information to be transmitted to a plurality of peer computers and stored in a distributed ledger replicated at each of the plurality of peer computers such that the non-confidential customer defined manufacturing order information stored in the plurality of the peer computers is accessible by the plurality of customers.

Similarly, block 212 directs the tracker processor 100 to produce signals representing the non-confidential vendor defined manufacturing order information for causing the non-confidential vendor defined manufacturing order information to be transmitted to the plurality of peer computers and stored in the distributed ledger such that the non-confidential vendor defined manufacturing order information stored in the plurality of the peer computers is associated with the non-confidential customer defined manufacturing order information and is accessible by the plurality of customers.

In some embodiments, block 206 may be executed concurrently with block 212 and/or blocks 206 and 212 may be combined as a single block which directs the tracker processor 100 to produce signals representing the information included in the non-confidential order information record 620 for causing the information included in the record 620 to be transmitted to a plurality of peer computers and stored in a distributed ledger.

In some embodiments, execution of blocks 206 and 212 may direct the tracker processor 100 to cause the information included in the non-confidential order information record 620 to be stored in a distributed ledger managed by a software package such as, Hyperledger™ Fabric. For example, in some embodiments, the system 10 may include a plurality of Hyperledger™ Fabric peers and a plurality of orderers. In some embodiments, for example, each of the tracker 14 and the vendor devices 22, 24, and 26 may each act as a Hyperledger™ Fabric peer. In some embodiments, the tracker 14 may also act as an orderer.

In some embodiments, the system 10 may include orderer peers that may be considered the central communication channel for the Hyperledger™ Fabric network and do not belong to individual organizations but to a network consortium, since orderer peers may be responsible for consistent ledger state across the entire network. In various embodiments, the system may include a Hyperledger™ Fabric network that is set by the organizations that intend to setup a consortium, such as for example, by the users of the tracker, vendor devices, and/or customer devices respectively.

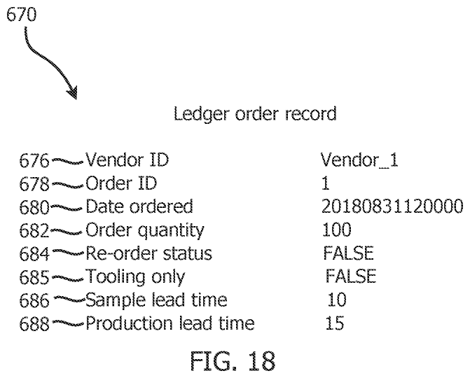

In such embodiments, blocks 206 and 212 may direct the tracker processor 100 to produce signals including information from the non-confidential order information record 620 for causing the information included in the record 620 to be transmitted to a peer such that the information is forwarded to an orderer and included in a distributed ledger shared by the peers. For example, in some embodiments, blocks 206 and 212 may direct the tracker processor 100 to produce signals representing a Hyperledger™ Fabric propose message including a proposed Hyperledger™ Fabric transaction for instantiating a ledger order record 670 as shown in FIG. 18 in the distributed ledger.

In some embodiments, where the tracker 14 acts as a peer, blocks 206 and 212 may direct the tracker processor 100 to invoke code included in the block of codes 172 for directing the tracker processor 100 to transmit to an orderer included in the system 10, a transaction for instantiating the ledger order record 670 shown in FIG. 18 in the distributed ledger, and the orderer of the system 10 may cause the ledger order record 670 shown in FIG. 18 to be stored at the plurality of peers included in the system 10. In various embodiments, the ledger order record 670 may include fields 676-688 which correspond to the fields 626-638 of the non-confidential order information record 620 shown in FIG. 17.

In various embodiments, by using the vendor devices 22, 24, and 26 that are controlled by the vendors, who may be generally adversarial to one another, as peers, the distributed ledger stored in these devices may be generally trustworthy.

In various embodiments, after blocks 206 and 212 have been executed, the ledger order record 670 may be stored in a distributed ledger which is accessible by the customer devices 16, 18, and 20. For example, in some embodiments, where Hyperledger™ Fabric software is used in the system 10, a customer device 16 may access the distributed ledger via the tracker 14, for example, by providing login credentials such that the tracker 14, acting as a peer, can provide the distributed ledger to the customer device 16. In some embodiments, the customer device 16 may access the distributed ledger using Hyperledger™ Fabric SDK or REST web service. In some embodiments, peers in a member organization may receive transaction invocation requests from clients inside the member organization. In some embodiments, a client may be a specific application serving specific organization/business activities. In some embodiments, connectivity to the Hyperledger™ Fabric network and a client application may be done through SDKs. In some embodiments, a client may need to be configured with private and public keys issued by organization certificate authority (CA). In some embodiments, this may enable all parties involved in the Hyperledger™ fabric network to be known identities.

In various embodiments, after blocks 206 and 212 have been executed, the tracker processor 100 may be directed to perform further tracking of manufacturing order information from the customer, the vendor, or both. For example, in some embodiments, the block of codes 170 of the program memory 102 shown in FIG. 2 may include further blocks of code which direct the tracker processor 100 to receive further vendor defined manufacturing order information associated with a manufacturing order, identify from the vendor defined manufacturing order information, non-confidential vendor defined manufacturing order information, and produce signals representing the non-confidential vendor defined manufacturing order information for causing the non-confidential vendor defined manufacturing order information to be transmitted to a plurality of peer computers and stored in the distributed ledger replicated at each of the plurality of peer computers such that the non-confidential vendor defined manufacturing order information stored in the plurality of the peer computers is associated with the non-confidential customer defined manufacturing order information and is accessible by the plurality of customers.

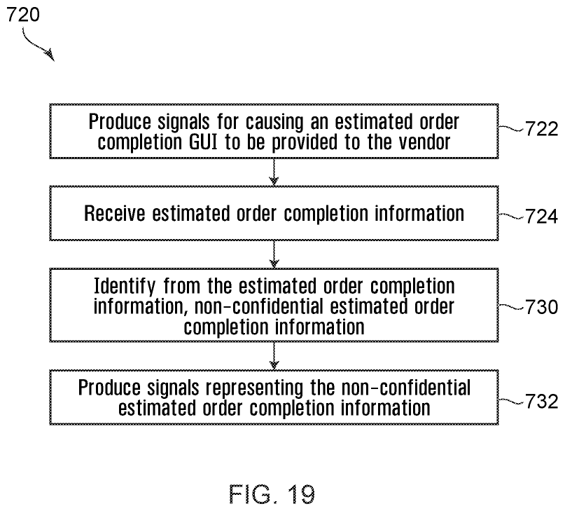

In some embodiments, for example, the block of codes 170 of the program memory 102 shown in FIG. 2 may include blocks of code as shown in the flowchart 720 shown in FIG. 19.

Referring to FIG. 19, the flowchart 720 depicts blocks of code which may generally direct the tracker processor 100 to receive vendor defined manufacturing order information associated with a manufacturing order, identify from the vendor defined manufacturing order information, non-confidential vendor defined manufacturing order information, and produce signals representing the non-confidential vendor defined manufacturing order information for causing the non-confidential vendor defined manufacturing order information to be transmitted to a plurality of peer computers and stored in a distributed ledger replicated at each of the plurality of peer computers such that the non-confidential vendor defined manufacturing order information stored in the plurality of the peer computers is associated with the non-confidential customer defined manufacturing order information and is accessible by the plurality of customers.

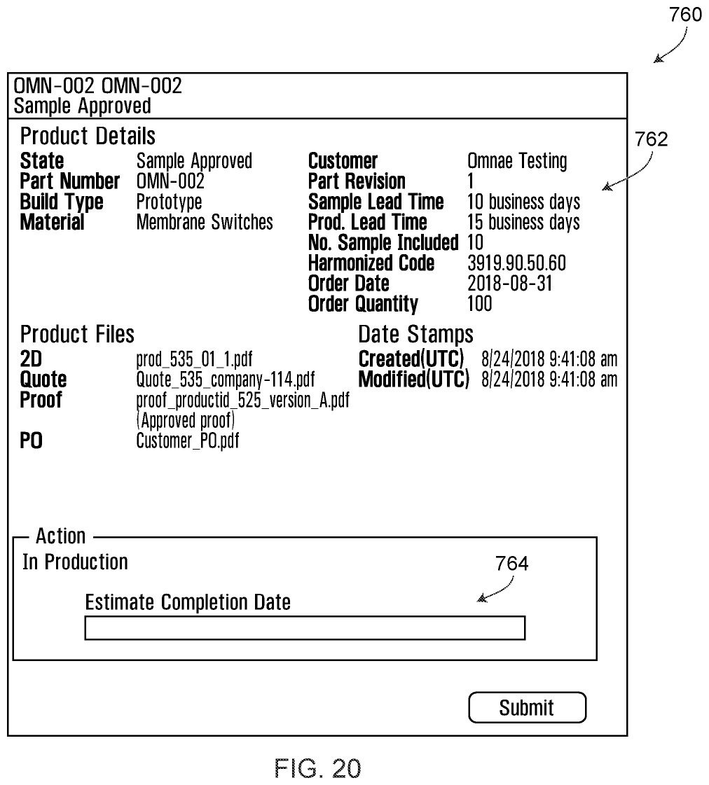

The flowchart 720 begins with block 722 which directs the tracker processor 100 to produce signals for causing an estimated order completion GUI to be provided to the vendor. For example, in some embodiments, block 722 may direct the tracker processor 100 to transmit signals to the vendor device 22 for causing the display of the vendor device 22 to display an estimated order completion GUI 760 as shown in FIG. 20 to the vendor.

In some embodiments, block 722 may direct the tracker processor 100 to produce signals for causing order information to be provided to the vendor. For example, in some embodiments, block 722 may direct the tracker processor 100 to transmit signals representing the order record 580 for causing order information included in the order record 580 to be displayed by the display of the vendor device 22, for example, as shown at 762 in FIG. 20. Referring to FIG. 20, the GUI 760 includes an input field 764 for use by the vendor in providing an estimated completion date. In various embodiments, the estimated completion date provided by the vendor may be the date on which the vendor expects to be able to ship the ordered parts to the customer.

The vendor may use the vendor device 22 to provide an estimated completion date, acting as estimated order completion information, and so the vendor device 22 may transmit an estimated order completion message 780 as shown in FIG. 21 to the tracker 14. In the embodiment shown, the estimated order completion message 780 includes an order identifier field 782 for storing a unique order identifier associated with the message 780 and an estimated completion date field 784 for storing the estimated completion date as provided by the vendor.

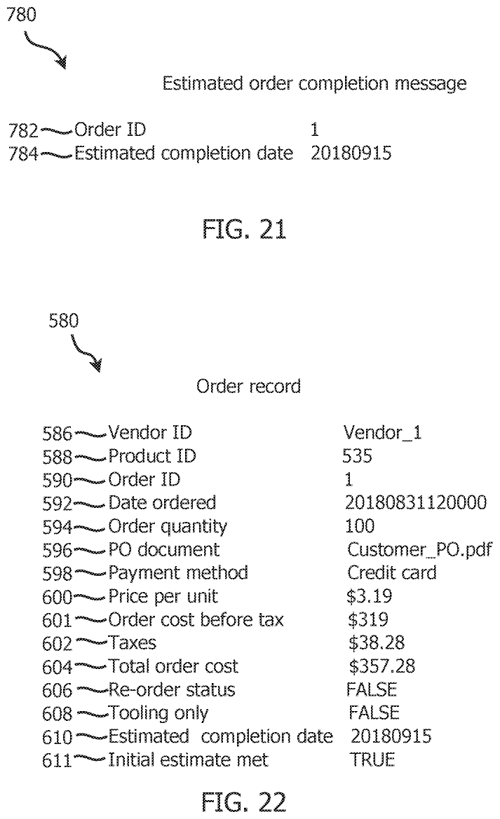

Referring to FIG. 19, block 724 directs the tracker processor 100 to receive estimated order completion information, which may act as vendor defined manufacturing order information. In various embodiments, block 724 may direct the tracker processor 100 to receive the estimated order completion message 780 from the vendor device 22. Block 724 may direct the tracker processor 100 to update the order record 580 stored in the location 152 of the storage memory 104 to include an estimated completion date field 610 (as shown in FIG. 22, which shows the order record 580 as it may appear in some embodiments, after block 724 of the flowchart 720 shown in FIG. 19 has been executed) storing the date from the estimated order completion message 780.

In some embodiments, block 724 may direct the tracker processor 100 to verify whether an estimated completion date is within a production lead time originally provided by a vendor. For example, in some embodiments, block 724 may direct the tracker processor 100 to add the production lead time in days, taken from the production lead time field 480 of the vendor quote record 460 stored in the location 150 of the storage memory 104, to the date from the date ordered field 490 of the order record 580 and determine whether the estimated completion date is after the resulting date. If the tracker processor 100 determines that the estimated completion date is after the resulting date, the tracker processor 100 may determine that the estimated completion date is not outside the original production lead time estimate and so block 724 may direct the tracker processor 100 to set an initial estimate met field 611 of the order record 580 to FALSE. If the tracker processor 100 determines that the estimated completion date is not after the resulting date, the tracker processor 100 may determine that the estimated completion date is not outside the original production lead time estimate and so block 724 may direct the tracker processor 100 to set the initial estimate met field 611 of the order record 580 to TRUE. The initial estimate met field 611 may thus store an indicator of whether the estimated completion date is within a production lead time originally provided by the vendor.

In various embodiments, block 730 may direct the tracker processor 100 to identify from the estimated order completion information non-confidential estimated order completion information. For example, in some embodiments, block 730 may direct the tracker processor 100 to identify the estimated completion date stored in the estimated completion date field 610 of the order record 580 and the initial estimate met flag stored in the initial estimate met field 611 of the order record 580 as non-confidential estimated order completion information.

Block 732 then directs the tracker processor 100 to produce signals representing the non-confidential estimated order completion information for causing the non-confidential estimated order completion information to be transmitted to the plurality of peer computers and stored in the distributed ledger such that the non-confidential estimated order completion information stored in the plurality of the peer computers is associated with the non-confidential customer defined manufacturing order information and is accessible by the plurality of customers.

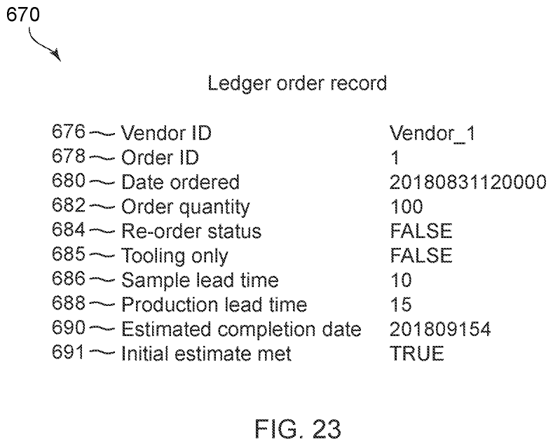

In some embodiments, block 732 may direct the tracker processor 100 to transmit signals representing a Hyperledger™ Fabric transaction to a peer and/or an orderer of the system 10 for causing the ledger order record 670 stored in the distributed ledger to be updated to include an estimated completion date field 690 and an initial estimate met field 691 as shown in FIG. 23 for storing the estimated completion date and the initial estimate met flag taken from the order record 580. In various embodiments, because block 732 may be executed after blocks 206 and 212 of the flowchart 200 were executed, the distributed ledger defining the ledger order record 670 may include a transaction that adds the estimated completion date field 690 and the initial estimate met field 691 to the ledger order record 670 in a later entry of the distributed ledger compared to the entry that instantiated the ledger order record 670. For example, where the distributed ledger includes a blockchain, the transaction that instantiated the ledger order record 670 may be included in a first block associated with a first time period and the transaction that added the estimated completion date field 690 and the initial estimate met field 691 to the ledger order record 670 may be included in a second block associated with a second time period subsequent to the first time period. In various embodiments, the time difference between the instantiation of the ledger order record 670 and the addition of the estimated completion date field 690 and the initial estimate met field 691 to the ledger order record 670 may be reviewable by a customer accessing the distributed ledger, for example, by reviewing the block at which the ledger was instantiated and the block at which the estimated completion date field 690 and the initial estimate met field 691 were added. In various embodiments, the time difference may make forging the ledger order record 670 as shown in FIG. 23 difficult and so may add to the trust of the customer in the authenticity of the ledger order record 670.

In various embodiments, after block 732 has been executed, the tracker processor 100 may be directed to perform additional or alternative tracking of manufacturing order information. For example, in some embodiments, the block of codes 170 of the program memory 102 shown in FIG. 2 may include further blocks of code which direct the tracker processor 100 to receive vendor defined manufacturing order information associated with a manufacturing order, identify from the vendor defined manufacturing order information, non-confidential vendor defined manufacturing order information, and produce signals representing the non-confidential vendor defined manufacturing order information for causing the non-confidential vendor defined manufacturing order information to be transmitted to the peer computers and stored in the distributed ledger replicated at each of the plurality of peer computers such that the non-confidential vendor defined manufacturing order information stored in the plurality of the peer computers is associated with the non-confidential customer defined manufacturing order information and is accessible by the plurality of customers.

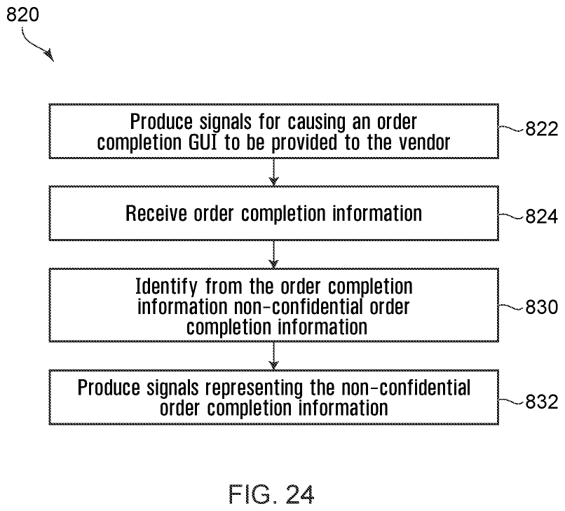

In some embodiments, for example, the block of codes 170 of the program memory 102 shown in FIG. 2 may include blocks of code as shown in the flowchart 820 shown in FIG. 24. In various embodiments, the flowchart 820 may be generally similar to the flowchart 720 except that the flowchart 820 deals with actual order completion information, once the order has been completed, rather than estimated order completion information.

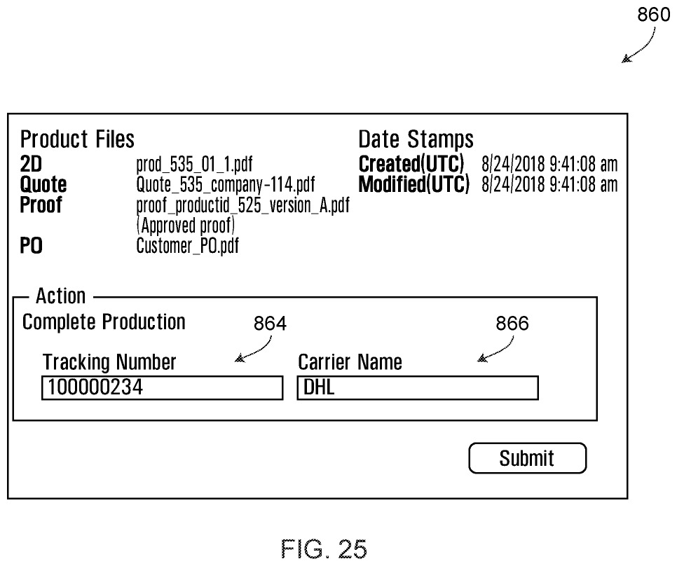

The flowchart 820 begins with block 822 which directs the tracker processor 100 to produce signals for causing an order completion GUI to be provided to the vendor. For example, in some embodiments, block 822 may direct the tracker processor 100 to transmit signals to the vendor device 22 for causing the display of the vendor device 22 to display an order completion GUI 860 as shown in FIG. 25 to the vendor.

Referring to FIG. 25, the GUI 860 includes a shipping tracking number input field 864 and a shipping carrier name input field 866 for use by the vendor in providing shipping information for the order. In various embodiments, the shipping information may be provided by the vendor once the vendor has completed production and the ordered parts have been or are being shipped to the customer.

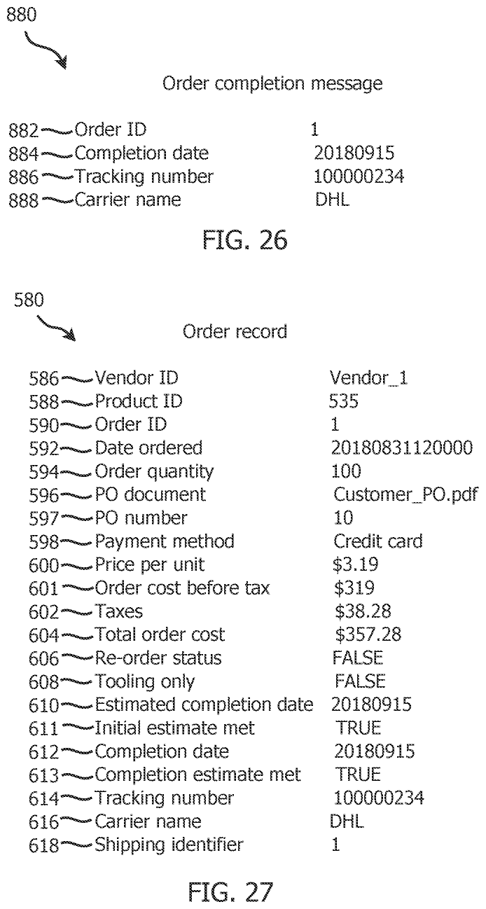

In various embodiments, the vendor may use the vendor device 22 to provide the shipping information by causing the vendor device 22 to transmit an order completion message 880 as shown in FIG. 26 to the tracker 14. In the embodiment shown, the order completion message 880 includes an order identifier field 882 for storing an order identifier identifying the order associated with the message 880, a completion date field 884 for storing the date on which the order completion took place (e.g., the date on which the order completion message 880 was generated), a tracking number field 886 for storing a shipping tracking number as provided by the vendor via the GUI 860, and a carrier name field 888 for storing a carrier name as provided by the vendor via the GUI 860.

Referring to FIG. 24, block 824 directs the tracker processor 100 to receive order completion information, which may act as vendor defined manufacturing order information. In various embodiments, block 824 may direct the tracker processor 100 to receive the order completion message 880 shown in FIG. 26 from the vendor device 22. Block 824 may direct the tracker processor 100 to update the order record 580 stored in the location 152 of the storage memory 104 to include a completion date field 612, a tracking number field 614, and a carrier name field 616 (as shown in FIG. 27, which shows the order record 580 as it may appear in some embodiments, after block 824 of the flowchart 820 shown in FIG. 24 has been executed) storing the information from the order completion message 880. In various embodiments, block 824 may also direct the tracker processor 100 to generate a unique shipping identifier associated with the completed shipment and to add a shipping identifier field 618 to the order record 580, as shown in FIG. 27.

In some embodiments, block 824 may direct the tracker processor 100 to verify whether the completion date is after the estimated completion date provided by a vendor. If the tracker processor 100 determines that the completion date is after the estimated completion date, the tracker processor 100 may determine that the estimated completion date is not within the original production lead time estimate and so block 724 may direct the tracker processor 100 to set a completion estimate met field 613 of the order record 580 to FALSE. If the tracker processor 100 determines that the completion date is not after the estimated completion date, the tracker processor 100 may determine that the completion date occurred by the estimated completion date and so block 824 may direct the tracker processor 100 to set the completion estimate met field 613 of the order record 580 to TRUE as shown in FIG. 27. The completion estimate met field 613 may thus store an indicator of whether the completion date is within the time period set by the estimated completion date and previously provided by the vendor.

Referring to FIG. 24, block 830 then directs the tracker processor 100 to identify from the order completion information, non-confidential order completion information. For example, in some embodiments, block 830 may direct the tracker processor 100 to identify the completion date and the completion estimate met flag included in the order record 580 as non-confidential order completion information.

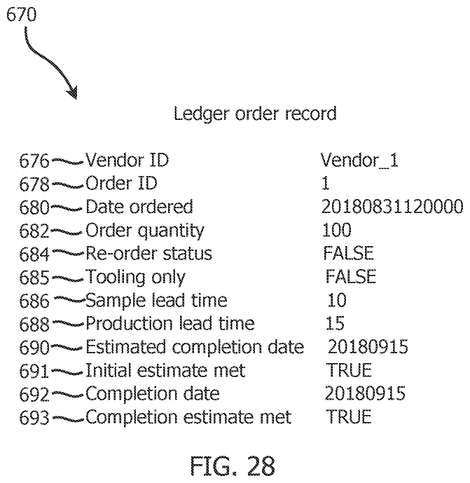

Block 832 then directs the tracker processor 100 to produce signals representing the non-confidential order completion information for causing the non-confidential order completion information to be transmitted to the plurality of peer computers and stored in the distributed ledger such that the non-confidential order completion information stored in the plurality of the peer computers is associated with the non-confidential customer defined manufacturing order information and is accessible by the plurality of customers. Block 832 may direct the tracker processor 100 to transmit signals representing a Hyperledger™ Fabric transaction to a peer and/or an orderer of the system 10 for causing the ledger order record 670 stored in the distributed ledger to be updated to include a completion date field 692 and completion estimate met field 693 as shown in FIG. 28 for storing the completion date and the completion estimate met flag taken from the order record 480.

In various embodiments, because block 832 may be executed after blocks 206, 212, and 732 of the flowcharts 200 and 720 were executed, the distributed ledger may reflect this time difference and it may make forging the ledger order record 670 as shown in FIG. 28 difficult and so may add to the trust of a customer in the authenticity of the ledger order record 670.

In various embodiments, the process as described herein regarding flowcharts 200, 720, and 820 for receiving information, identifying non-confidential information, and updating the ledger order record 670 may be repeated for a plurality of parts and/or orders such that a plurality of ledger order records having generally the same format as the ledger order record 670 may be stored in the distributed ledger. As discussed above, the ledger order records may be accessible by customers, for example, by using the customer devices 16, 18, and 20 included in the system 10. Accordingly, in various embodiments, the customers may be able to review various non-confidential order information included in the ledger order records stored in the distributed ledger. In some embodiments, a customer may be able to use the information included in the ledger order records to make manufacturing decisions, such as, for example, regarding vendor selection and/or manufacturing scheduling. For example, in some embodiments, a customer may review the information included in the ledger order records and ascertain a vendor's historical ability to meet their initial lead time estimates and/or their estimated completion dates. In some embodiments, because the ledger order records are stored on a distributed ledger, these records may be trusted by the customers. In some embodiments, timing of transactions or entries added to the distributed ledger may be compared with ledger order record dates to strengthen a customer's trust in the distributed ledger.

Confidential Information Handling

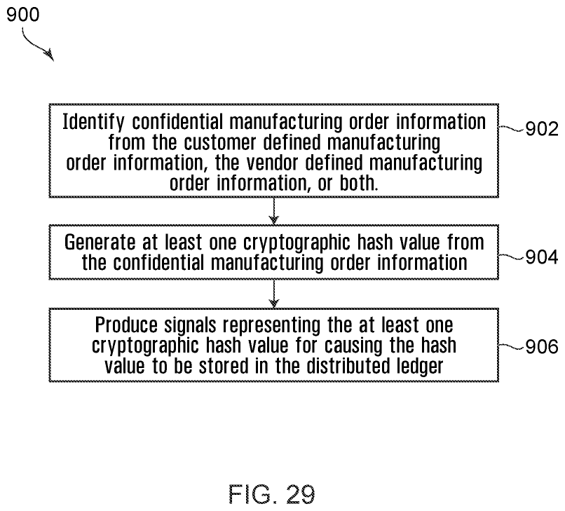

In various embodiments, the tracker 14 may be configured to track confidential information using a distributed ledger. For example, in some embodiments, after blocks 202 and/or 208 of the flowchart 200 shown in FIG. 3 have been executed, the tracker processor 100 may be directed to perform confidential manufacturing order information tracking functions. In some embodiments, after blocks 202 and 208 of the flowchart 200 have been executed, the tracker processor 100 may execute flowchart 900 as shown in FIG. 29. In various embodiments, the blocks of code included in the flowchart 900 may be encoded in the block of codes 170 of the program memory 102 shown in FIG. 2 for example.

Referring to FIG. 29, flowchart 900 begins with block 902 which directs the tracker processor 100 to identify confidential manufacturing order information from the customer defined manufacturing order information, the vendor defined manufacturing order information, or both. In some embodiments, block 902 may direct the tracker processor 100 to identify confidential manufacturing order information from at least one of the part record 300, the vendor quote record 460, and/or the order record 580. In some embodiments, block 902 may direct the tracker processor 100 to identify a subset of manufacturing order information that is confidential and to be tracked using a distributed ledger. In some embodiments, a definition of which fields included in the part record 300, vendor quote record 460 and order record 580 include confidential information may be hardcoded in the block of codes 902.

In some embodiments, block 902 may direct the tracker processor 100 to read the part record 300 as shown in FIG. 7 from the location 142 of the storage memory 104 shown in FIG. 2 and to identify the information included in the product identifier field 304 and the part number field 310 as confidential manufacturing information that is to be tracked using the distributed ledger. In some embodiments, block 902 may direct the tracker processor 100 to read the order record 580 as shown in FIG. 15 from the location 152 of the storage memory 104 and to identify the information included in the PO number field 597, the price per unit field 600, the order cost before tax field 601, the taxes field 602, and the total order cost field 604 as confidential manufacturing information that is to be tracked using the distributed ledger.

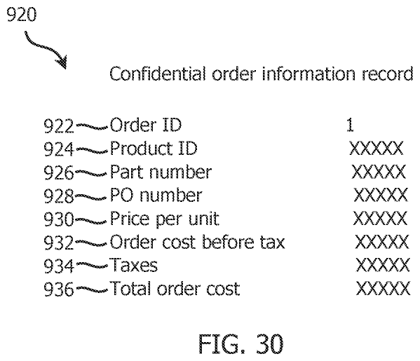

Block 904 then directs the tracker processor 100 to generate at least one cryptographic hash value from the confidential manufacturing order information. In various embodiments, block 904 may direct the tracker processor 100 to generate a confidential order information record 920 as shown in FIG. 30 including an order identifier field 922 for storing the unique order identifier associated with the confidential order information record and fields 924-934 for storing hash values generated by applying a cryptographic hash function to the confidential order information identified at block 902. In various embodiments, the hash generated may be useable as evidence of possession of the information from which it was generated. In some embodiments, for example, the cryptographic hash function may be a Secure Hash Algorithm, such as SHA256.

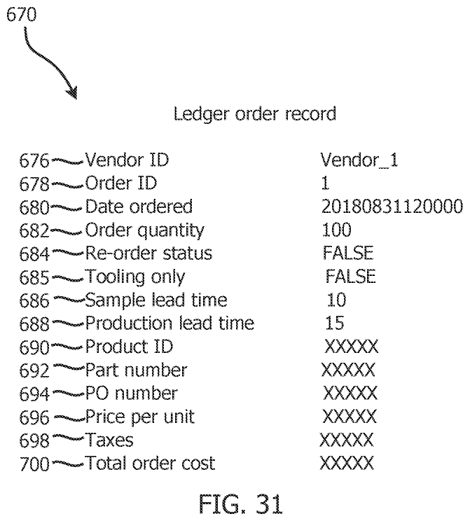

Block 906 then directs the tracker processor 100 to produce signals representing the at least one cryptographic hash value for causing the at least one cryptographic hash value to be transmitted to the plurality of peer computers to be stored in the distributed ledger such that the cryptographic hash value is associated with the non-confidential customer defined manufacturing order information and is accessible by the plurality of customers. In various embodiments, block 906 may be executed concurrently with blocks 206 and 212 of the flowchart 200. In some embodiments, block 906 may include code generally similar to that included in the block 206 and 212 and may direct the tracker processor 100 to cause the information included in the confidential order information record 920 to be stored in the distributed ledger in association with the non-confidential order information. For example, in some embodiments, execution of block 906 may cause the ledger order record 670 stored in the distributed ledger to be updated to include fields 690-700 as shown in FIG. 31.

As described above, in various embodiments, block 906 may be executed concurrently with blocks 206 and 212 of the flowchart 200 and so in some embodiments, the distributed ledger may be updated to include both the non-confidential order information and confidential order information at generally the same time. In such embodiments, where the distributed ledger includes a blockchain, for example, both the non-confidential order information and the associated confidential order information may be stored in the same block. In some embodiments, this may provide evidence that the non-confidential order information and the confidential order information were known and provided to the distributed ledger at generally the same time or time period.

In various embodiments, because the hash of the confidential information is stored in the distributed ledger, a user of the tracker 14 may be able to prove that the information which generated the hash was stored by the tracker 14 at a certain time.

Non-Conformance Information Tracking

In some embodiments, the tracker 14 may be configured to track alternative or additional customer defined manufacturing information and/or vendor defined manufacturing information. In some embodiments, the block of codes 170 may include alternative and/or additional blocks for directing the tracker processor 100 to receive alternative and/or additional customer and/or vendor defined manufacturing order information, identify non-confidential information from the customer and/or vendor defined manufacturing order information and produce signals for causing the non-confidential information to be stored in the distributed ledger. For example, in some embodiments, the tracker 14 may be configured to track non-conformance report information, which may act as the customer defined manufacturing order and/or vendor defined manufacturing order information. For example, in some embodiments, the customer defined manufacturing order information and/or the vendor defined manufacturing order information may include incident analysis information and/or incident correction information.

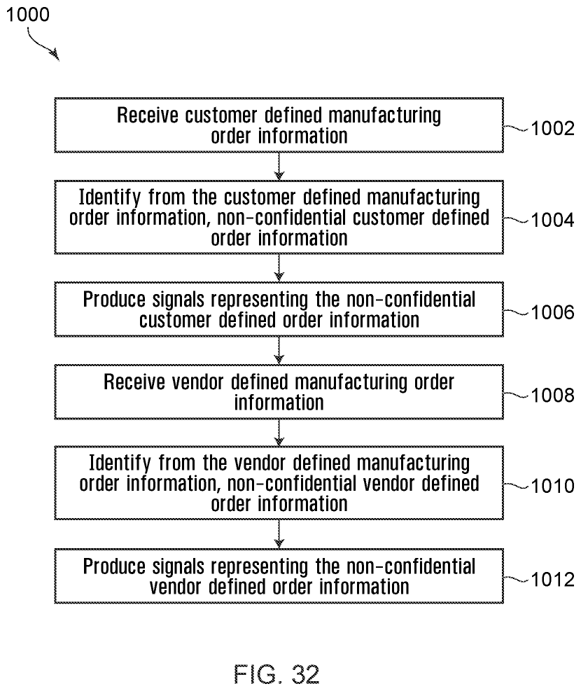

Referring to FIG. 32, a flowchart depicting blocks of code for directing the tracker processor 100 shown in FIG. 2 to perform tracking of manufacturing order non-conformance information in accordance with various embodiments is shown generally at 1000. In various embodiments, the blocks of code included in the flowchart 1000 may direct the tracker processor 100 to facilitate tracking of manufacturing order non-conformance information for a plurality of manufacturing customers. The blocks of code included in the flowchart 1000 may be encoded in the block of codes 171 of the program memory 102 shown in FIG. 2 for example.

Referring to FIG. 32, the flowchart 1000 includes blocks for directing the tracker processor 100 to perform tracking of manufacturing order information, which may include code that is generally similar to code included in the flowchart 200 shown in FIG. 3. The flowchart 1000 begins with block 1002, which directs the tracker processor 100 shown in FIG. 2 to receive customer defined manufacturing order information associated with a manufacturing order, the customer defined manufacturing order information generated by one of the customers. In some embodiments, block 1002 may direct the tracker processor 100 to receive non-conformance report information from a customer device.

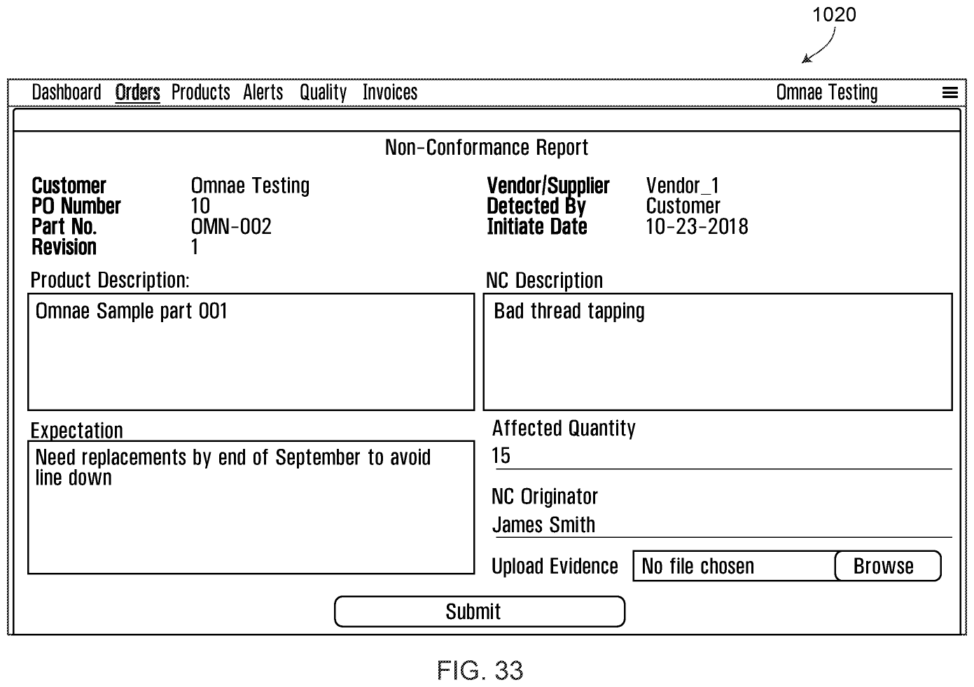

In various embodiments, the flowchart 1000 may be initiated by a customer using one of the customer devices 16, 18, and 20. For example, in some embodiments, a customer using the customer device 16 may have noticed a non-conformance in parts they received related to the order record 580 shown in FIG. 27. The customer may use the customer device 16 to request a non-conformance report (“NCR”) generation GUI from the tracker 14 and block 1002 may direct the tracker processor 100 to produce signals for causing an NCR generation GUI, for example, generally as shown at 1020 in FIG. 33, to be provided or displayed by a display of the customer device 16, to the customer.

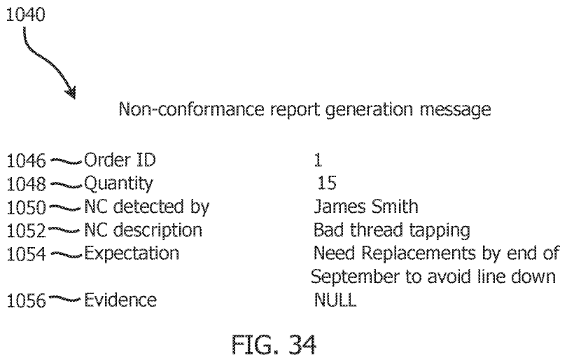

In various embodiments, the customer may interact with the NCR generation GUI 1020 to cause the customer device 16 to generate and send NCR generation information to the tracker 14. For example, in some embodiments, the customer may interact with the NCR generation GUI 1020 to input values into fields, as shown in FIG. 33, for example, and cause the customer device 16 to generate and send an NCR generation message 1040 as shown in FIG. 34 to the tracker 14. The NCR generation GUI may include aspects generally similar to other GUIs described and/or shown herein, such as, for example, fillable forms and/or features for allowing information and/or computer files to be transmitted or uploaded from the vendor device 22 to the tracker 14.

Referring to FIG. 34, the NCR generation message 1040 includes an order identifier field 1046 for storing a unique order identifier identifying the order associated with the non-conforming parts, a quantity field 1048 for storing a quantity of parts that are non-conforming (out of the order total), an NC detected by field 1050 for storing a name of the individual that detected/reported the NC, an NC description field 1052 for storing a customer-provided detailed description of the non-conformance, an expectation field 1054 for storing a customer-provided description of what corrective action the customer requires to avoid hardship, and an evidence field 1056 for optionally storing customer-provided image information which may act as evidence of the non-conformance.

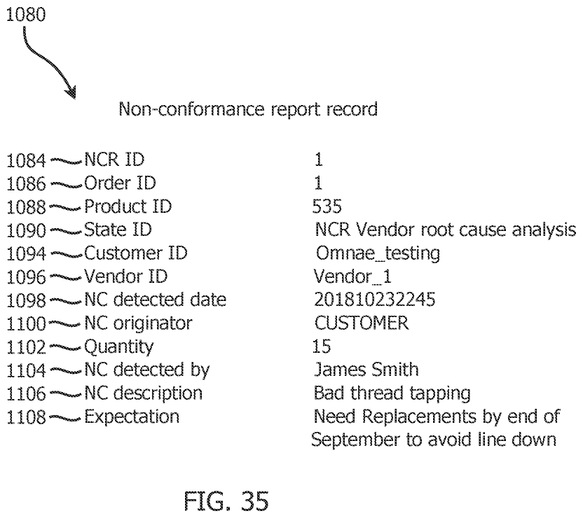

In some embodiments, block 1002 may direct the tracker processor 100 to receive the NCR generation message 1040 shown in FIG. 34 from the customer device 16 shown in FIG. 1, for example. Block 1002 may direct the tracker processor 100 to generate an NCR record 1080 as shown in FIG. 35 in response to receiving the NCR generation message 1040.

Referring to FIG. 35, the NCR record 1080 includes an NCR identifier field 1084, an order identifier field 1086, a product identifier field 1088, a state identifier field 1090, a customer identifier field 1094, a vendor identifier field 1096, an NC detected date field 1098, an NC originator field 1100, a quantity field 1102, an NC detected by field 1104, an NC description field 1106, and an expectation field 1108. In various embodiments, block 1002 of the flowchart 1000 shown in FIG. 32 may direct the tracker processor 100 to fill in the order identifier field 1086, the quantity field 1102, the NC detected by field 1104, the NC description field 1106, and the expectation field 1108 with values from the NCR generation message 1040 shown in FIG. 34.

Block 1002 may direct the tracker processor 100 to generate and store a unique NCR identifier in the NCR identifier field 1084. Block 1002 may direct the tracker processor 100 to use the order identifier from the order identifier field 1046 of the NCR generation message 1040 to fill in the order identifier field 1086 and to look up the associated product identifier, customer identifier, and vendor identifier from the order record 580 and the part record 300 and to store those in the fields 1088, 1094, and 1096 of the NCR record 1080 shown in FIG. 35.

Block 1002 may direct the tracker processor 100 to set the state identifier field 1090 to a representation of a state of the non-conformance report. In some embodiments, block 1002 may direct the tracker processor 100 to set the state identifier field 1090 to “NCR Vendor root cause analysis” to indicate that the current state of the NCR is one in which the vendor is to provide root cause analysis.

Block 1002 may direct the tracker processor 100 to set the NC detected date field 1098 to a representation of the date at which the NCR generation message was generated, which in some embodiments, may be the current date and time.

Block 1002 may direct the tracker processor 100 to set the NC originator field 1100 to a representation of a party from which the NCR originated. For example, in various embodiments, the NC originator field 1100 may be chosen from a representation of “CUSTOMER”, “VENDOR”, or “TRACKER”, to represent that either the customer, vendor or an administrator of the tracker 14 generated the NCR. In various embodiments, where the NCR generation message was generated by a customer, the NC originator field 110 may be set to “CUSTOMER”.

Block 1002 may direct the tracker processor 100 to store the NCR record 1080 in the location 156 of the storage memory 104 shown in FIG. 2. In various embodiments, information included in the NCR record 1080 shown in FIG. 35 may act as customer defined manufacturing order information.

Referring to FIG. 32, block 1004 then directs the tracker processor 100 to identify from the customer defined manufacturing order information, non-confidential customer defined manufacturing order information. In various embodiments, block 1004 may direct the tracker processor 100 to identify information from the NCR record 1080 stored in the location 156 of the storage memory 104 as non-confidential information. In some embodiments, block 1004 may direct the tracker processor 100 to identity a subset of the customer defined manufacturing order information as non-confidential. In some embodiments, a definition of which fields included in the NCR record 1080 shown in FIG. 35 include non-confidential information may be hardcoded in the block of codes 1004, for example. In various embodiments, by identifying which of the NCR information is non-confidential, the tracker processor 100 may be able to allow access to the information, to third parties, such as other customers, for their benefit.

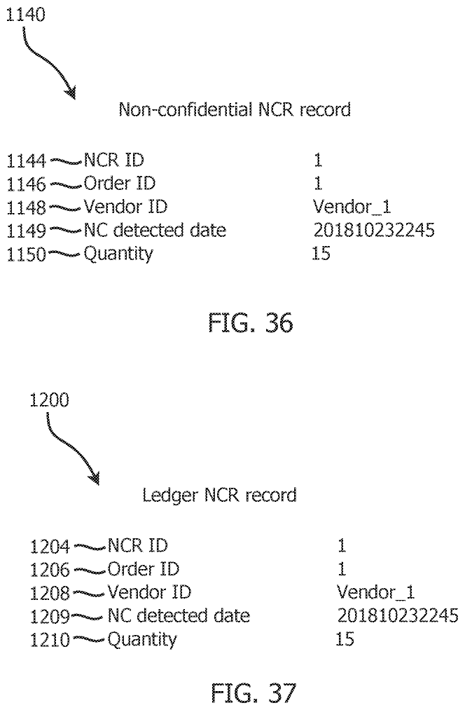

In some embodiments, block 1004 may direct the tracker processor 100 to generate a non-confidential NCR record 1140 as shown in FIG. 36 including an NCR identifier field 1144, an order identifier field 1146, a vendor identifier field 1148, an NC detected date field 1149, and a quantity field 1150 and to store the record 1140 in the location 154 of the storage memory 104 shown in FIG. 2. Block 1004 may direct the tracker processor 100 to copy values from corresponding fields in the NCR record 1080 into the fields 1144, 1146, 1148, 1149, and 1150 of the non-confidential NCR record 1140 shown in FIG. 36. The information included in at least fields 1146, 1148, 1149, and 1150 of the non-confidential NCR record 1140 shown in FIG. 36 may act as non-confidential customer defined manufacturing order information.

Block 1006 then directs the tracker processor 100 to produce signals representing the non-confidential customer defined manufacturing order information for causing the non-confidential customer defined manufacturing order information to be transmitted to a plurality of peer computers and stored in a distributed ledger replicated at each of the plurality of peer computers such that the non-confidential customer defined manufacturing order information stored in the plurality of the peer computers is accessible by the plurality of customers. In various embodiments, block 1006 may include generally similar code to that included in block 206 of the flowchart 200 shown in FIG. 3.

For example, in some embodiments, block 1006 may direct the tracker processor 100 to cause information included in the non-confidential NCR record 1140 to be stored in a distributed ledger managed by a software package such as, Hyperledger™ Fabric. For example, in some embodiments, block 1006 may direct the tracker processor 100 to invoke code included in the block of codes 172 for directing the tracker processor 100 to transmit to an orderer included in the system 10, a transaction for instantiating a ledger NCR record 1200 as shown in FIG. 37 in the distributed ledger, and the orderer of the system 10 may cause the ledger NCR record 1200 to be stored at the plurality of peers included in the system 10.

In various embodiments, the ledger NCR record 1200 may include fields 1204, 1206, 1208, 1209, and 1210 which correspond to the fields 1144, 1146, 1148, 1149, and 1150 of the non-confidential NCR record 1140 shown in FIG. 36.

In various embodiments, the vendor devices 22, 24, and 26 may be used as peers and by using the vendor devices that are controlled by the vendors who may be generally adversarial to one another, as peers, the distributed ledger stored in these devices may be generally trustworthy.

Referring back to FIG. 32, block 1008 directs the tracker processor 100 to receive vendor defined manufacturing order information associated with the manufacturing order, the vendor defined manufacturing order information generated by one of a plurality of manufacturing vendors. In various embodiments, block 1008 may direct the tracker processor 100 to transmit a representation of the NCR record 1080 to a vendor device associated with the vendor identified by the vendor identifier field 1096 included in the NCR record 1080, for causing an NCR analysis GUI showing information included in the NCR record 1080 to be provided to the vendor. For example, in some embodiments, block 1008 may direct the tracker processor 100 to transmit a representation of the NCR record 1080 to the vendor device 22.

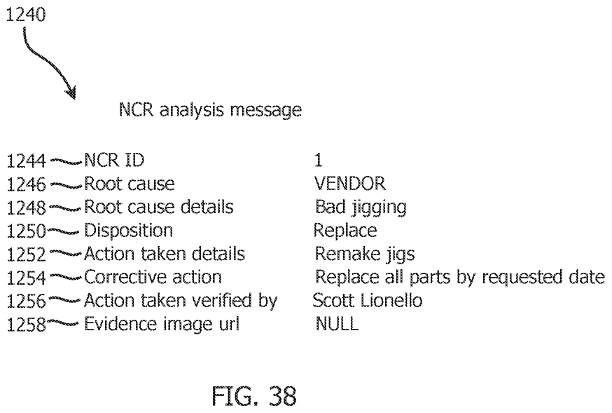

In various embodiments, the vendor may consider the information from the NCR record 1080 and use the vendor device 22 to interact with the NCR analysis GUI to cause the vendor device 22 to generate and send NCR analysis information to the tracker 14. For example, in some embodiments, the vendor may interact with the NCR analysis GUI to cause the vendor device 22 to generate and send an NCR analysis message 1240 as shown in FIG. 38 to the tracker 14.

Referring to FIG. 38, the NCR analysis message 1240 includes an NCR identifier field 1244 for storing the unique NCR identifier associated with the non-conformance and the NCR record 1080 and a root cause field 1246 for storing a vendor supplied identifier of which party caused the non-conformance. In some embodiments, the root cause of the non-conformance may be chosen from a representation of CUSTOMER, VENDOR, TRACKER, and SHIPPER, depending on which of these entities the vendor determines to have caused the non-conformance.

The NCR analysis message 1240 also includes a root cause details field 1248 for storing a description of the root cause of the non-conformance, a disposition field 1250 for storing a description of what is to be done with the non-conforming parts, an action taken details field 1252 for storing a description of what action will be taken to prevent recurrence of the non-conformance, a corrective action field 1254 for storing a description of what action will be taken to correct the non-conformance, an action taken verified by field 1256 for storing an identification of who on the vendor side will oversee actions for handling the non-conformance, and an evidence image URL field 1258 for storing a URL that points to evidence of the non-conformance.

In various embodiments, the vendor may use the NCR analysis GUI displayed by the vendor device 22 to provide data to be included in the NCR analysis message 1240 shown in FIG. 38. The NCR analysis GUI may include aspects generally similar to other GUIs described and/or shown herein, such as, for example, fillable forms and/or features for allowing information and/or computer files to be transmitted or uploaded from the vendor device 22 to the tracker 14.

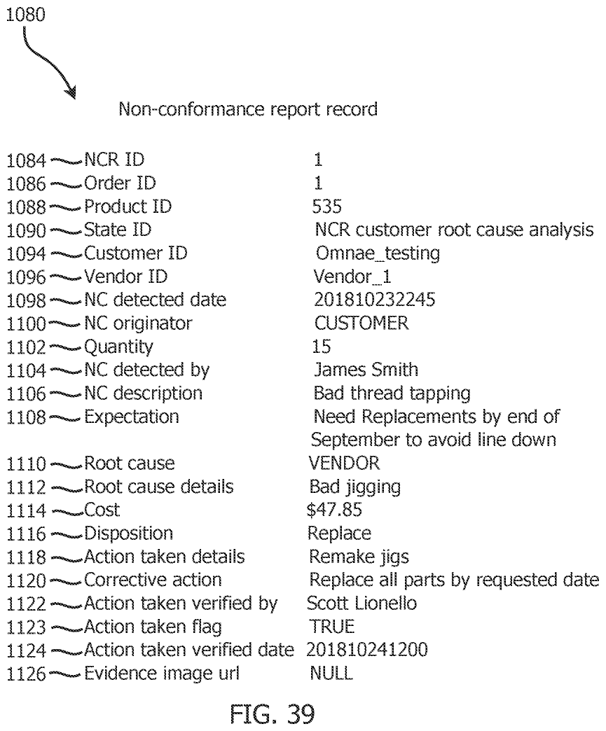

Referring to FIG. 32, block 1008 may direct the tracker processor 100 to receive the NCR analysis message 1240 from the vendor device 22. Block 1008 may direct the tracker processor 100 to update the NCR record 1080 as shown in FIG. 39 in response to receiving the NCR generation message 1040.

Block 1008 may direct the tracker processor 100 to add fields 1110-1126 to the NCR record 1080 shown in FIG. 39. Block 1008 may direct the tracker processor 100 to copy values from the fields 1246-1258 of the NCR analysis message into the respective fields 1110, 1112, 1116, 1118, 1120, 1122, and 1126 of the NCR record 1080. For replacements and/or scrapped parts, block 1008 may direct the tracker processor 100 to determine a cost to be stored in the cost field 1114 based on the quantity stored in the quantity field 1102 and the price per unit field 600 of the order record 580 shown in FIG. 27. For example, in some embodiments, block 1008 may direct the tracker processor 100 to determine the cost by multiplying the quantity by the price per unit. In some embodiments, a value for the cost field 1114 may be provided by the vendor, for example, for NCRs where the solution requires reworking. Block 1008 may direct the tracker processor 100 to set the action taken flag field 1123 to a value of TRUE to represent that corrective action has been taken and to use a current time and date for the action taken verified date field 1124 to represent a time and date that the NCR analysis message 1240 was received. In various embodiments, information included in the fields 1110-1126 of the NCR record 1080 shown in FIG. 39 may act as vendor defined manufacturing information.

Block 1008 may direct the tracker processor 100 to set the state identifier field 1090 to a representation of a state of the non-conformance report. In some embodiments, block 1008 may direct the tracker processor 100 to set the state identifier field 1090 to “NCR customer root cause review” to indicate that the current state of the NCR is one in which the customer is to review the root cause analysis.

Referring back to FIG. 32, block 1010 directs the tracker processor 100 to identify from the vendor defined manufacturing order information, non-confidential customer defined manufacturing order information. In various embodiments, block 1010 may direct the tracker processor 100 to identify at least some of the information from fields 1110-1126 of the NCR record 1080 stored in the location 156 of the storage memory 104 as non-confidential information. In some embodiments, block 1004 may direct the tracker processor 100 to identity a subset of the vendor defined manufacturing order information as non-confidential. In some embodiments, a definition of which fields included in the NCR record 1080 shown in FIG. 39 include non-confidential information may be hardcoded in the block of codes 1010, for example. In various embodiments, by identifying which of the NCR information is non-confidential, the tracker processor 100 may be able to allow access to the information, by third parties, such as other customers, for their benefit.

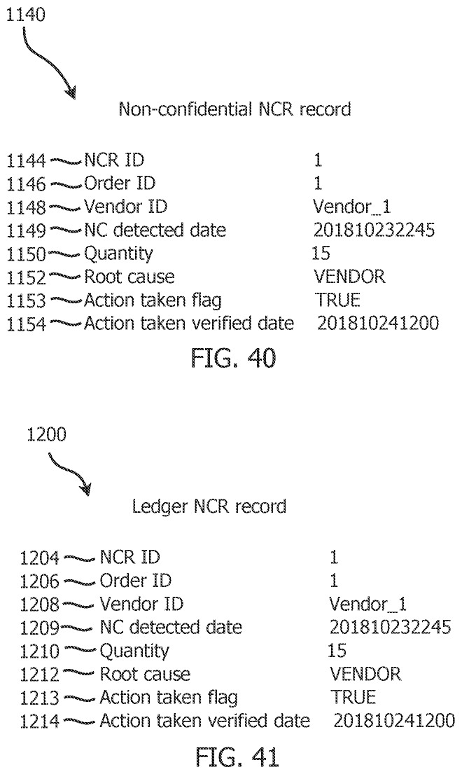

In some embodiments, block 1010 may direct the tracker processor 100 to update the non-confidential NCR record 1140 as shown in FIG. 40 to include a root cause field 1152, an action taken flag field 1153, and an action taken verified date field 1154. Block 1010 may direct the tracker processor 100 to copy values from corresponding fields in the NCR record 1080 into the fields 1152, 1153, and 1154 of the non-confidential NCR record 1140 shown in FIG. 40. Information included in the fields 1152, 1153, and 1154 of the non-confidential NCR record 1140 shown in FIG. 40 may act as non-confidential vendor defined manufacturing order information.

Block 1012 then directs the tracker processor 100 to produce signals representing the non-confidential vendor defined manufacturing order information for causing the non-confidential order information to be transmitted to the plurality of peer computers and stored in the distributed ledger such that the non-confidential vendor defined manufacturing order information stored in the plurality of the peer computers is associated with the non-confidential customer defined manufacturing order information and is accessible by the plurality of customers. In various embodiments, block 1012 may include generally similar code to that included in block 732 of the flowchart 720 shown in FIG. 19.

For example, in some embodiments, block 1010 may direct the tracker processor 100 to cause information from the fields 1152 and 1154 of the non-confidential NCR record 1140 to be stored in a distributed ledger managed by a software package such as, Hyperledger™ Fabric. For example, in some embodiments, block 1012 may direct the tracker processor 100 to invoke code included in the block of codes 172 for directing the tracker processor 100 to transmit to an orderer included in the system 10, a transaction for updating the ledger NCR record 1200 to include fields 1212, 1213, and 1214 as shown in FIG. 41, and the orderer of the system 10 may cause the ledger NCR record 1200 to be updated as shown in FIG. 41 and stored at the plurality of peers included in the system 10. In various embodiments, the transaction updating the ledger NCR record 1200 to include fields 1212, 1213, and 1214 may be stored in a later ledger entry or block of the distributed ledger compared to the block that stores the contents of the fields 1204, 1206, 1208, 1209, and 1210 of the ledger NCR record 1200. In various embodiments, storage in a later block may add to the trustworthiness of the ledger NCR record 1200, since it may make it more difficult to make later changes to the ledger NCR record 1200.

In various embodiments, the flowchart 1000 may end after block 1012 is executed. In some embodiments, however, additional blocks generally similar to blocks 1002-1006 and/or 1008-1012 may be executed wherein further customer defined NCR information and/or further vendor defined NCR information is received by the tracker 14 and the NCR record 1080 is updated.

In some embodiments, the customer may use the customer device 16 to review the NCR record 1080 and, when satisfied that the NCR record 1080 is correct and has been resolved, provide an NCR closed message.

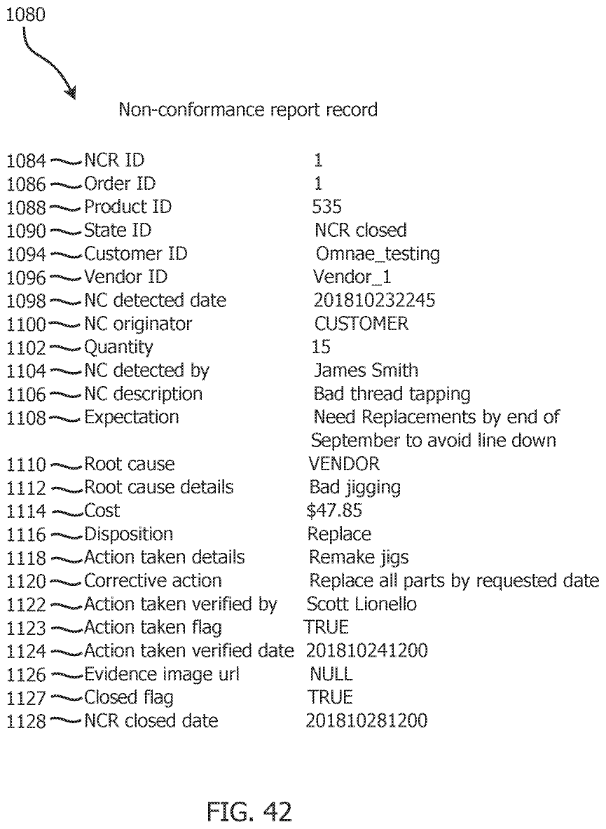

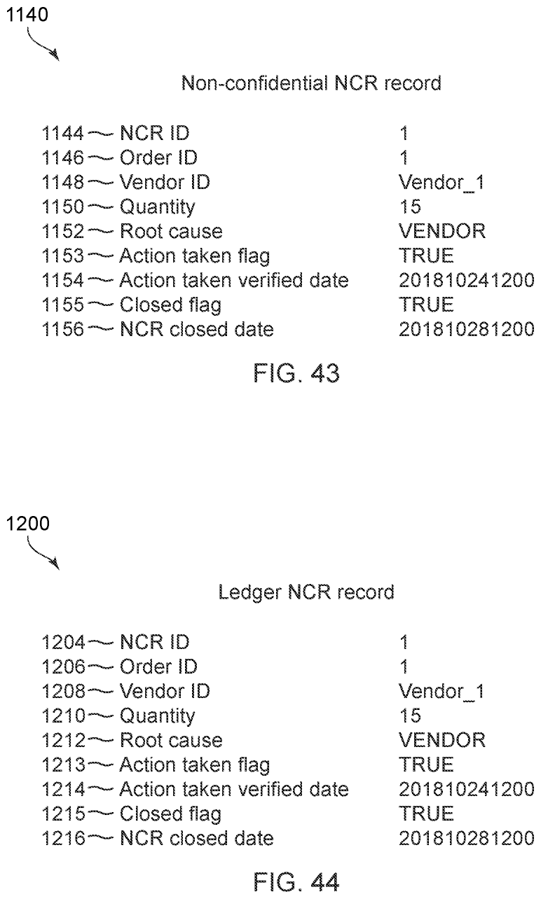

In various embodiments, the block of codes 171 of the program memory 102 may include code for directing the tracker processor 100 to receive the NCR closed message from the customer device 16 and to update the NCR record 1080 as shown in FIG. 42 to include a closed flag field 1127 for storing a representation of whether the NCR has been closed and an NCR closed date field 1128 for storing a date and time at which the NCR was closed, which may be the date and time at which the NCR closed message was received. In some embodiments, the block of codes 171 may include code for directing the tracker processor 100 to identify the information included in the closed flag field 1127 and the NCR closed date field 1128 as non-confidential, to update the non-confidential NCR record 1140 to include fields 1155 and 1156 as shown in FIG. 43, and to produce signals for causing the ledger NCR record 1200 to be updated to include a closed flag field 1215 and an NCR closed date field 1216 as shown in FIG. 44.

The code may further direct the tracker processor 100 to set the state identifier field 1090 of the NCR record 1080 to a representation of a state of the non-conformance report. In some embodiments, block 1008 may direct the tracker processor 100 to set the state identifier field 1090 to “NCR closed” to indicate that the current state of the NCR is one in which the NCR is closed.

In some embodiments, a user or third party who is neither the customer nor the vendor may provide further NCR information and such further NCR information may be identified as non-confidential and stored in the distributed ledger. For example, in some embodiments, in the case where a third-party NCR administrator needs to act as a mediator in settling a dispute, the NCR administrator may use an admin device in communication with the tracker 14 to review the NCR record 1080 and, when satisfied that the NCR record 1080 is correct and has been resolved, provide an NCR closed message.

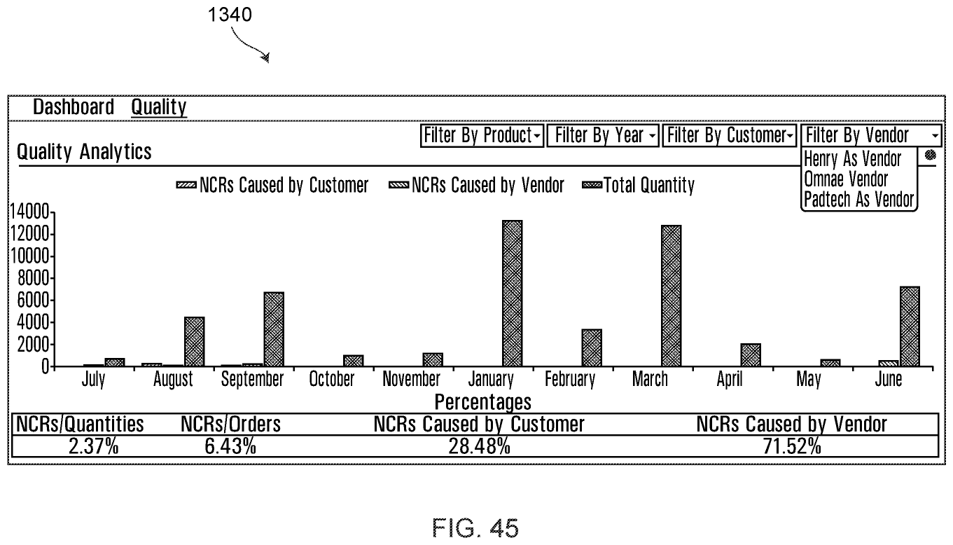

In various embodiments, the flowchart 1000 may be repeated for a plurality of non-conformances reported by a plurality of customers and/or a plurality of vendors. Accordingly, in various embodiments, the distributed ledger may store a plurality of ledger NCR records having generally similar format to the ledger NCR record 1200 shown in FIG. 44. In various embodiments, a customer may access the distributed ledger and review the stored ledger NCR records and may use the information included in the NCR records to determine whether they wish to use a particular vendor, or to choose which vendor they wish to use for manufacturing a part. For example, in some embodiments, a customer may use a customer device to request quality analytics representing the NCR records from the tracker 14. In some embodiments, the block of codes 171 of the program memory 102 may include code for directing the tracker processor 100 to receive a request for quality analytics for a particular vendor and to produce signals representing the ledger NCR records associated with the particular vendor for causing a quality analytics display to be displayed by the customer device 16 to the customer. For example, a quality analytics display 1340 that may be displayed by the customer device 16 is shown in FIG. 45. In some embodiments, the customer device 16 may access the distributed ledger using Hyperledger™ Fabric SDK or REST web service.

In various embodiments, the tracker 14 may be configured to track confidential information included in the NCR record 1080 shown in FIGS. 35, 39, and 42 using the distributed ledger. For example, in some embodiments, after blocks 1002 and/or 1008 of the flowchart 1000 shown in FIG. 32 have been executed, the tracker processor 100 may be directed to perform confidential manufacturing order information tracking functions. In some embodiments, after blocks 1002 and/or 1008 of the flowchart 1000 have been executed, the tracker processor 100 may execute blocks generally similar to those included in the flowchart 900 as shown in FIG. 29, to cause confidential information from the customer defined manufacturing order information and from the vendor defined manufacturing order information included in the NCR record 1080 to be cryptographically hashed and stored in the distributed ledger. For example, the confidential information may include data stored in the product identifier field 1088, state identifier field 1090, customer identifier field 1094, NC detected date field 1098, NC originator field 1100, NC detected by field 1104, NC description field 1106, expectation field 1108, root cause details field 1112, cost field 1114, disposition field 1116, action taken details field 1118, corrective action field 1120, action taken verified by field 1122, and evidence image URL field 1126 of the NCR record 1080 shown in FIG. 42.

In various embodiments, because the hash of the confidential information is stored in the distributed ledger, a user of the tracker 14 may be able to prove that the information which generated the hash was stored by the tracker 14 at a certain time. In various embodiments, for process conformance, this may speak to turn-around time on the task for customer/vendor (e.g., how quickly do they complete root cause analysis, etc.). In some embodiments, this may also show that persisted data was written in a step by step basis during the NCR investigation period and not after the fact.

### Various Embodiments

In some embodiments, the customer may have an opportunity to reject the root cause analysis provided by the vendor and represented by the NCR analysis message 1240 shown in FIG. 38. In such embodiments, the block of codes 171 of the program memory 102 may include code for directing the tracker processor 100 to receive an NCR root cause review message from the customer device 16. In some embodiments, the NCR root cause review message may include a reject corrective action reason field, a reject root cause reason field, or a reject corrective parts reason field for storing a customer provided description of why the customer rejected the corrective action reason, root cause reason, or corrective parts. In various embodiments, the block of codes 171 of the program memory 102 may include code for directing the tracker processor 100 to add the information from the reject corrective action reason field, reject root cause reason field, or reject corrective parts reason field to a corresponding field in the NCR record and to generally treat the information as confidential customer defined manufacturing order information.

In various embodiments, the vendor may have the opportunity to provide information supporting the vendor's view that the customer was the root cause of a non-conformance. In such embodiments, the NCR analysis message 1240 may include a root cause on customer reason field for storing a vendor provided description of why the customer was the cause of the non-conformance (e.g., damage or bad engineering) and a root cause on customer evidence image reference URL field for storing an image reference URL providing evidence that the customer was the cause of the non-conformance. In such embodiments, block 1006 of the flowchart 1000 shown in FIG. 32 may direct the tracker processor 100 to add corresponding fields to the NCR record 1080 for storing the above information. In various embodiments, the information included in the root cause on customer reason field and the root cause on customer evidence image reference URL field may be generally treated as confidential vendor defined manufacturing order information.

In some embodiments, the vendor may provide shipping information for corrective parts being provided as part of the action taken by the vendor. In such embodiments, the block of codes 171 of the program memory 102 may include code for directing the tracker processor 100 to receive an NCR shipping message from the vendor device 22. In some embodiments, the NCR shipping message may include a shipping carrier name field and a shipping tracking number field. In various embodiments, the block of codes 171 of the program memory 102 may include code for directing the tracker processor 100 to add the information from the shipping carrier name field and the shipping tracking number field to corresponding fields in the NCR record and to generally treat the information as confidential vendor defined manufacturing order information.

In various embodiments, additional or alternative distributed ledgers to the Hyperledger™ Fabric distributed ledger described herein may be used in a system generally similar to the system 10 shown in FIG. 1. For example, in some embodiments, the tracker 14 may be configured to cause information to be stored in a public blockchain instead of a private distributed ledger. For example, in some embodiments, the tracker 14 may be configured to cause information to be stored in a public blockchain, such as, for example the Ethereum or Bitcoin blockchains. In such embodiments, the system 10 may include a plurality of peers configured to store the public blockchain.

In some embodiments, after blocks 206 and 212 of the flowchart 200 shown in FIG. 3 have been executed, other blocks of code may be executed for finalizing the order. For example, in some embodiments, the vendor may use the vendor device 22 to send a proof to the tracker 14 which may be configured to present the proof to the customer via the customer device 16 for the customer's review and approval. In such embodiments, the tracker 14 may facilitate communication of the proof from the vendor to the customer and communication of the approval of the proof by the customer. In some embodiments, the vendor may produce a sample and ship the sample to the customer and the customer may review and approve the sample. In such embodiments, the tracker 14 may facilitate communication of shipping information for the sample from the vendor to the customer and communication of approval of the sample by the customer to the vendor. In various embodiments, after the sample has been approved, the vendor may provide estimated completion information, and the tracker processor 100 may execute the flowchart 720 shown in FIG. 19.

In some embodiments, customer defined manufacturing order information may be provided by or originate from alternative or additional sources other than a customer user inputting the information using a customer device. For example, in some embodiments, customer defined manufacturing order information may be received or captured from a customer database, for example, when onboarding existing manufacturing solutions.

In some embodiments, vendor defined manufacturing information may be provided by or derived from alternative or additional sources other than a vendor user inputting the information using a vendor device. For example, in some embodiments, vendor defined manufacturing order information may be received or captured from vendor side databases, for example, when onboarding existing manufacturing solutions.

In some embodiments, functionality described herein as performed by the tracker 14 may be performed at least in part by one or more of the customer devices 16, 18, and 20 and/or one or more of the vendor devices 22, 24, and 26. For example, in some embodiments, each of the customer devices 16, 18, and 20 may include program memory storing code for directing the customer device to perform various functionality described herein as performed by the tracker 14. For example, in some embodiments, each of the customer devices 16, 18, and 20 may be configured to execute code generally corresponding to any or all of the blocks 202, 204, and 206 of the flowchart 200 shown in FIG. 3 and/or generally corresponding to any or all of the blocks 1002, 1004, and 1006 of the flowchart 1000 shown in FIG. 32. In some embodiments, each of the vendor devices 22, 24, and 26 may include program memory storing code for directing the customer device to perform various functionality described herein as performed by the tracker 14. For example, in some embodiments, each of the vendor devices 22, 24, and 26 may be configured to execute code generally corresponding to any or all of the blocks 208, 210, and 212 of the flowchart 200 shown in FIG. 3 and/or generally corresponding to any or all of the blocks 1008, 1010, and 1012 of the flowchart 1000 shown in FIG. 32.

While specific embodiments of the invention have been described and illustrated, such embodiments should be considered illustrative of the invention only and not as limiting the invention as construed in accordance with the accompanying claims.

1. A computer-implemented method of facilitating tracking of manufacturing information for a plurality of manufacturing customers, the method comprising:
causing at least one processor to receive customer defined manufacturing order information associated with a manufacturing order, the customer defined manufacturing order information generated by one of the plurality of manufacturing customers;
causing the at least one processor to identify from the customer defined manufacturing order information, non-confidential customer defined manufacturing order information;
causing the at least one processor to produce signals representing the non-confidential customer defined manufacturing order information and causing the non-confidential customer defined manufacturing order information to be transmitted to at least one storage location accessible by a plurality of peer computers and stored such that the non-confidential customer defined manufacturing order information is accessible by the plurality of customers;
causing the at least one processor to receive vendor defined manufacturing order information associated with the manufacturing order, the vendor defined manufacturing order information generated by one of a plurality of manufacturing vendors;
causing the at least one processor to identify from the vendor defined manufacturing order information, non-confidential vendor defined manufacturing order information;
causing the at least one processor to produce signals representing the non-confidential vendor defined manufacturing order information and causing the non-confidential vendor defined manufacturing order information to be transmitted to the at least one storage location accessible by the plurality of peer computers and stored such that the non-confidential vendor defined manufacturing order information is associated with the non-confidential customer defined manufacturing order information and is accessible by the plurality of customers.

2. The method of claim 1 further comprising:
causing the at least one processor to identify confidential manufacturing order information from the customer defined manufacturing order information, the vendor defined manufacturing order information, or both;
causing the at least one processor to generate at least one cryptographic hash value from the confidential manufacturing order information; and
causing the at least one processor to produce signals representing the at least one cryptographic hash value and causing the at least one cryptographic hash value to be transmitted to the at least one storage location accessible by the plurality of peer computers to be stored such that the cryptographic hash value is associated with the non-confidential customer defined manufacturing order information and is accessible by the plurality of customers.

3. The method of claim 2 wherein:
causing the at least one processor to produce the signals representing the non-confidential customer defined manufacturing order information and causing the non-confidential customer defined manufacturing order information to be transmitted to the at least one storage location accessible by the plurality of peer computers comprises causing the at least one processor to produce signals for causing the non-confidential customer defined manufacturing order information to be stored in a first block of memory at the storage location, the first block associated with a first time period; and
causing the at least one processor to produce the signals representing the cryptographic hash value and causing the at least one cryptographic hash value to be transmitted to the at least one storage location accessible by the plurality of peer computers comprises causing the at least one processor to produce signals for causing the at least one cryptographic hash value to be stored in the first block of memory, such that the first block provides evidence that the non-confidential customer defined manufacturing order information and the at least one cryptographic hash value were stored during the first time period,
wherein data stored at the at least one storage location is immutable once stored.

4. The method of claim 3 wherein causing the at least one processor to produce the signals representing the non-confidential vendor defined manufacturing order information and causing the non-confidential vendor defined manufacturing order information to be transmitted to the at least one storage location comprises causing the at least one processor to produce signals for causing at least a portion of the non-confidential vendor defined manufacturing order information to be stored in a second block of memory at the storage location, the second block associated with a second time period subsequent to the first time period.

5. The method of claim 1 wherein the customer defined manufacturing order information includes order creation information defining a proposed product order and wherein the vendor defined manufacturing order information includes at least one of estimated order completion information, or order completion information.

6. The method of claim 1 wherein the customer defined manufacturing order information includes non-conformance report information and wherein the vendor defined manufacturing order information includes at least one of non-conformance analysis information or non-conformance correction information

7. A system for facilitating tracking of manufacturing information for a plurality of manufacturing customers comprising at least one processor configured to perform the method of claim 1.

8. A non-transitory computer readable medium having stored thereon codes which when executed by at least one processor cause the at least one processor to perform the method of claim 1.

9. The method of claim 1, wherein the at least one storage location accessible by a plurality of peer computers is a distributed ledger replicated at each of the plurality of peer computers.

10. The method of claim 1 further comprising:
causing the at least one processor to receive customer defined non-conformance information, the customer defined non-conformance information generated by the one of the plurality of manufacturing customers;
causing the at least one processor to identify from the customer defined non-conformance information, non-confidential customer defined non-conformance information;
causing the at least one processor to transmit the non-confidential customer defined non-conformance information to the at least one storage location accessible by the plurality of peer computers;
causing the at least one processor to receive vendor defined non-conformance information responsive to the customer defined non-conformance information, the vendor defined non-conformance information generated by the one of the plurality of manufacturing vendors;
causing the at least one processor to identify from the vendor defined non-conformance information, non-confidential vendor defined non-conformance information;
causing the at least one processor to transmit the non-confidential vendor defined non-conformance information to the at least one storage location accessible by the plurality of peer computers.

11. The method of claim 10, wherein the non-confidential customer defined non-conformance information is time stamped upon transmission to or receipt by the at least one storage location, and wherein the non-confidential vendor defined non-conformance information is time stamped upon transmission to or receipt by the at least one storage location.

12. The method of claim 11, further comprising providing to at least one of the plurality of peer computers an analytical report based on the time stamps associated with the non-confidential customer defined non-conformance information and the non-confidential vendor defined non-conformance information.

13. The method of claim 12, wherein the at least one storage location includes information associated with a plurality of instances of customer defined non-conformance information and responsive vendor defined non-conformance information, and wherein the analytical report includes data based on time stamps associated with the plurality of instances.

14. The method of claim 13, wherein the plurality of instances is associated with the one of the plurality of manufacturing vendors.

15. The method of claim 13, wherein each instance of customer defined non-conformance information is associated with a state identification, and wherein any customer defined non-conformance information is considered in the analytical report only if the associated state identification indicates that the instance is resolved.

16. The method of claim 11 wherein the customer defined non-conformance information is an indication that the customer has reported non-conformance with corresponding customer defined manufacturing order information and the vendor defined non-conformance information indicates that the non-conformance reported by the customer has been resolved.

17. The method of claim 16 further comprising causing the at least one processor to receive customer confirmation that the vendor defined non-conformance information is accurate.

18. The method of claim 16 wherein the non-confidential vendor defined non-conformance information comprises a root cause identification for the reported non-conformance and indicates whether action has been taken responsive to the customer defined non-conformance information.
